(19) United States
(12) Patent Application Publication
(10) Pub. No.: US 2006/0093325 A1
(43) Pub. Date: May 4, 2006

(54) Data recording controller, method of controlling data recording controller, program, data recording system, and data recording device

(76) Inventors: Mitsuhiro Imai, Yokohama (JP); Masataka Okayama, Fujisawa (JP); Akira Tanaka, Kawasaki (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/262,817

(22) Filed: Nov. 1, 2005

(30) Foreign Application Priority Data
Nov. 2, 2004 (JP) 2004-318922

(51) Int. Cl. H04N 5/76; G06F 13/00; G06F 3/00

(52) U.S. Cl. 386/83; 725/58

(57) ABSTRACT

The invention relates to preventing recording from failing because of concentration of recording and recording reservation in a specific device in recording via a network. Concretely, the invention relates to a data recording controller connected to data recording devices provided with a recording medium so that communication is possible. The data recording controller receives input of recording start time and recording termination time of data of broadcast voice and images, receives a maximum simultaneous recording number which can be simultaneously written to each recording medium, receives a simultaneous recording reserved number which are scheduled to be written to each recording medium from the recording start time to the recording termination time and stores a data recording device where the simultaneous recording reserved number is smaller than the maximum simultaneous recording number.

### CLAIM OF PRIORITY

The present application claims priority from Japanese application serial no. JP 2004-318922, filed on Nov. 2, 2004, the content of which is hereby incorporated by reference into this application.

### BACKGROUND OF THE INVENTION

The present invention relates to a data recording controller, a method of controlling the data recording controller, a program, a data recording system, and a data recording device.

To record a TV program, program data received by a broadcast receiver such as a tuner is stored in a storage such as a hard disk in a hard disk drive (HDD) and others. At this time, normally, the broadcast receiver and the storage are provided in the same system. Therefore, while the broadcast receiver is receiving program data, another program cannot be recorded. If the memory capacity of the storage is short, a program cannot be recorded, either.

In the meantime, recently, technique for recording a program via a network configured by an IEEE 1394 cable and an Ethernet (a trademark) cable or by radio has been developed. According to this technique, a broadcast receiver and a storage can be provided in different systems (for example, refer to JP-A-2000-349833 (Patent Reference 1) and JP-A-2004-158969 (Patent Reference 2)).

In the Patent Reference 1, when the recording of a predetermined program is reserved, a data amount required for recording the reserved program is calculated and a device provided with a recording medium that can record the calculated data amount out of devices connected via a network is searched. According to the result of the search, the allocation of a data amount to be recorded in each device is determined and a recordable area of each recording medium is secured so that the determined data amount can be recorded.

In the Patent Reference 2, a resource information database for monitoring a situation of the resources of each device connected via a network is prepared. For example, if memory capacity as a resource of a certain device is short, a device having a resource to spare is selected out of other devices based upon the resource information database, and an actual situation of the resource of the selected device is inquired via the network. When it is verified that the resource of the device has room, the resource in the device is remotely operated.

### SUMMARY OF THE INVENTION

The number of program data which can be simultaneously recorded in a HDD recorder where a broadcast receiver and a storage are provided in the same system is limited by the number of broadcast receivers.

If program data received by the broadcast receiver is recorded in a storage of another device connected via the network, recording or the reservation of recording may concentrate in a specific device. In that case, the device has to simultaneously execute a large number of recording processes. However, if recording or the reservation of recording exceeds the recording throughput of the device, a problem such as a program cannot be normally recorded may occur.

In the methods described in the Patent Reference 1 and the Patent Reference 2, when a storage suitable for recording is selected out of the devices provided with the storages connected to the network, a storage having large free capacity is selected. In this case, recording or the reservation of recording concentrates in a specific device provided with the storage having large free capacity.

The invention is made in view of the above-mentioned programs and the main object is to provide a data recording controller, a method of controlling the data recording controller, a program, a data recording system and a data recording device for preventing recording or the reservation of recording that exceeds recording throughput from concentrating in a specific device when recording via a network configured by wire or by radio is made.

To solve the above-mentioned problems, the invention is related to the data recording controller characterized in that it is connected to at least one data recording device having a recording medium for recording data of broadcast voice and images via a network so that communication is possible, and it is provided with a data recording reservation information input unit which receives, from a user interface, input of data recording reservation information at least including information showing recording start time and recording termination time of the data of broadcast voice and images and describing conditions when the data of voice and images is recorded and a simultaneous data recording number receiving unit which receives, from each data recording devices, information showing the number of the data pieces of voice and images which each of the data recording devices can simultaneously write to each recording medium, a data recording reservation number receiving unit which receives, from each of the data recording devices, information showing the number of data pieces of voice and images which each of the data recording devices is scheduled to write to each recording medium from the recording start time to the recording termination time shown in the data recording reservation information and a data recording device candidate memory unit which stores identification information of a data recording device in which the number of data pieces of voice and images scheduled to be written on a recording medium from the recording start time to the recording termination time shown in the data recording reservation information is smaller than the number of the simultaneously writable data pieces of voice and images as a candidate of a data recording device for recording the data of voice and images from the recording start time to the recording termination time shown in the data recording reservation information.

The above-mentioned problems and the method of solving them disclosed in the specification will be disclosed by preferred embodiments for embodying the invention and the drawings. The word “simultaneous” in the specification means not “simultaneous” in strict meaning but “parallel” at the substantially same timing.

According to the invention, if recording via a network is made, efficient recording is enabled. For example, it can be expected that the so-called omission of processing or a hang-up can be prevented from being caused in a recording device and failure of recording can be prevented.

### BRIEF DESCRIPTION OF THE DRAWINGS

FIG. 1 shows the whole configuration of a data recording system in this embodiment;

FIG. 2 shows the configuration of a receiving device in this embodiment;

FIG. 3 shows the configuration of a recording device in this embodiment;

FIG. 4 shows the configuration of a recording controller in this embodiment;

FIG. 5 shows a device profile information table in this embodiment;

FIG. 6 shows a simultaneous recording possible/impossible judgment table in this embodiment;

FIG. 7 shows a network-connected device information table in this embodiment;

FIG. 8 shows a recording reservation information table in this embodiment;

FIG. 9 shows a recording device candidate information table in this embodiment;

FIG. 10 shows a receiving device candidate information table in this embodiment;

FIG. 11 shows a recording reservation management table in this embodiment;

FIG. 12 shows an example of system configuration in this embodiment;

FIG. 13 is a block diagram showing a digital television set in this embodiment;

FIG. 14 is a block diagram showing a HDD recorder in this embodiment;

FIG. 15 is a flowchart showing a procedure for reserving recording in this embodiment;

FIG. 16 is a flowchart showing a procedure for determining recording in this embodiment;

FIG. 17 is a flowchart showing a procedure for determining a recording device in this embodiment;

FIG. 18 is a subroutine showing a procedure for determining a receiving device in this embodiment;

FIG. 19 is a flowchart showing a procedure for manual recording in this embodiment;

FIG. 20 is a flowchart showing a procedure for reserving recording in this embodiment;

FIG. 21 shows a device profile information table in this embodiment;

FIG. 22 shows a network-connected device information table in this embodiment;

FIG. 23 shows a recording device candidate information table in this embodiment;

FIG. 24 shows a receiving device candidate information table in this embodiment;

FIG. 25 shows an example of a display screen for determining a recording device in this embodiment;

FIG. 26 shows an example of a display screen for determining a recording device in this embodiment;

FIG. 27 shows an example of a display screen for determining a recording device in this embodiment;

FIG. 28 shows an example of a display screen for selecting a receiving device in this embodiment; and

FIG. 29 shows an example of a display screen for selecting a recording device and a receiving device in this embodiment.

### DETAILED DESCRIPTION OF THE PREFERRED EMBODIMENTS

=== Example of Whole Configuration ===

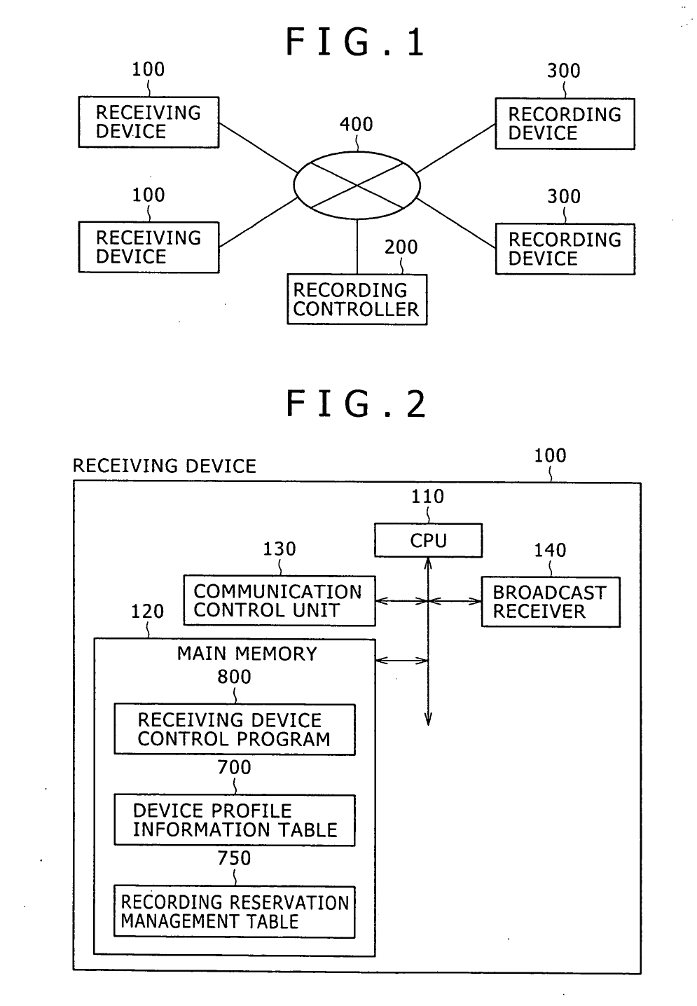

FIG. 1 shows an example of the whole configuration of a data recording system equivalent to this embodiment.

In the data recording system equivalent to this embodiment, at least one recording controller (equivalent to a data recording controller in the invention) 200, at least one receiving device (equivalent to a receiver in the invention) 100 and at least one recording device (equivalent to a data recording device in the invention) 300 are connected via a network 400 so that they can communicate with each other.

The receiving device 100 is provided with a broadcast receiver for receiving broadcast voice and images. The broadcast receiver is configured as a tuner for receiving various types of broadcasts such as digital satellite broadcasting, digital ground-based broadcasting and digital communication antenna television system or digital cable television (digital CATV) broadcasting. The digital satellite broadcasting includes digital communication satellite (CS) broadcasting and digital broadcast satellite (BS) broadcasting respectively already executed in Japan and the digital ground-based broadcasting includes digital ground-based broadcasting already executed in Japan. In this embodiment, the receiving device 100 will be described as a receiver for the digital ground-based broadcasting. Needless to say, the invention is not limited to the digital ground-based broadcasting and can also be applied to analog television broadcasting and various types of radio broadcasting such as AM, FM and short wave broadcasting. Further, the receiving device 100 may also be configured so that it can receive plural types of broadcasting formats. Hereinafter, broadcast voice and images will also be described as a broadcast program.

The recording device 300 is provided with a storage (equivalent to a recording medium in the invention) for recording the data of voice and an image and records the data of a broadcast program received by the receiving device 100 in the storage. Hereinafter, recording the data of a broadcast program in the storage will also be described as recording a broadcast program.

The recording controller 200 selects the receiving device 100 that receives a broadcast program and the recording device 300 that records the broadcast program out of each receiving device 100 and each recording device 300 respectively configuring the data recording system. The recording controller 200 accepts the input of an instruction to record a broadcast program and the input of various recording conditions (data recording reservation information) including recording start time, recording termination time, a channel and an image quality mode via a user interface. The recording controller 200 transmits a request to receive the broadcast program and a request to record the broadcast program (a request for recording) to the selected receiving device 100 and the selected recording device 300 when it is the recording start time. The broadcast program received by the receiving device 100 is transmitted to the selected recording device 300 via the network 400. The recording controller 200 instructs the receiving device 100 to terminate the receiving of the broadcast program and instructs the recording device 300 to terminate the recording of the broadcast program when it is the recording termination time.

The receiving and the recording of a broadcast program are not started and terminated according to an instruction from the recording controller 200 but the receiving device 100 and the recording device 300 may also start and terminate the receiving and the recording of a broadcast program without depending upon an instruction from the recording controller 200. In this case, a request for receiving and a request for recording including various recording conditions are transmitted from the recording controller 200 to the receiving device 100 and the recording device 300 before recording is started.

A broadcast program currently being watched can also be recorded. In this case, when the recording controller 200 receives the input of an instruction to record and the input of various recording conditions (data recording reservation information) including an image quality mode via a user interface, the recording controller selects the recording device 300 that records a broadcast program out of each recording device 300 configuring the data recording system. The recording controller instructs the receiving device 100 currently receiving the broadcast program to transmit the broadcast program currently being received to the recording device 300 and instructs the selected recording device 300 to record the broadcast program.

<Receiving Device>

FIG. 2 shows the configuration of the receiving device 100.

The receiving device 100 is provided with a CPU 110, a main memory 120, a communication control unit 130 and a broadcast receiver 140.

The CPU 110 controls the whole receiving device 100 and realizes various functions as the receiving device 100 by executing a receiving device control program 800 stored in the main memory 120 and configured by codes for enabling various operations in this embodiment. For example, when the CPU 110 executes the receiving device control program 800 and collaborates with hardware equipment such as the main memory 120, the communication control unit 130 and the broadcast receiver 140, a receiving schedule memory unit, a broadcast receiving controlling unit, a receiving schedule transmitting unit and a receiving schedule addition controlling unit are realized.

The main memory 120 is used for a work area by the CPU 110 and stores the receiving device control program 800, a device profile information table 700 and a recording reservation management table 750. For example, the main memory as the work area can be realized by a random access memory (RAM) and the main memory which stores the above-mentioned program and tables can be realized by a read only memory (ROM).

The receiving device control program 800 is a program for making the receiving device 100 function. For example, the receiving device control program is a program for having control for receiving broadcast voice and images and transmitting the data of the received voice and images to the recording device 300 via the network 400. The receiving device control program 800 may also be configured by plural programs.

The device profile information table 700 stores information showing functions with which each device (the receiving device 100, the recording controller 200 and the recording device 300) configuring the data recording system is provided.

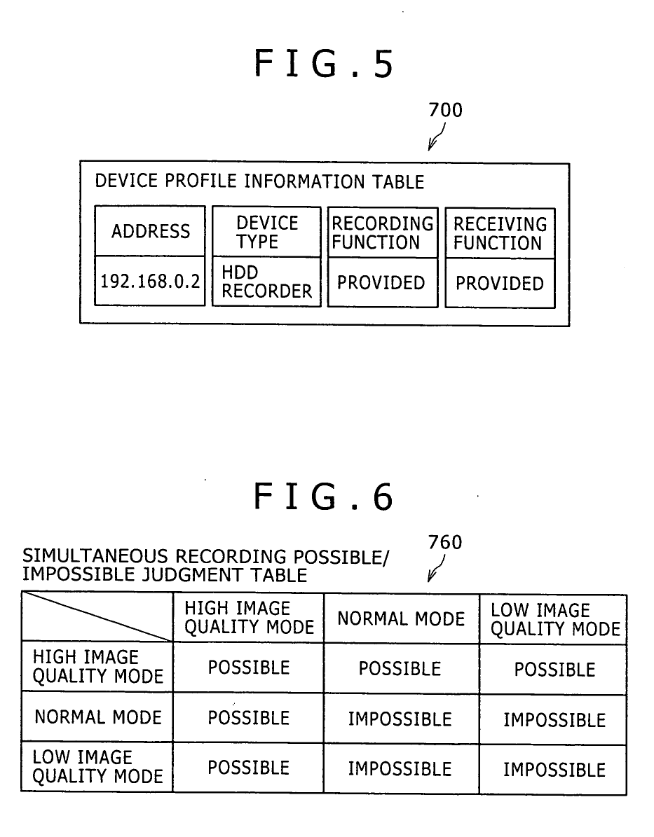

FIG. 5 shows an example of the device profile information table 700. The device profile information table 700 is provided with an “address” field, a “device type” field, a “recording function” field and a “receiving function” field. In the address field, the identification information of each device in case communication is made via the network 400 is stored. In the device type field, the type of each device is stored. The device type includes a HDD recorder, a DVD recorder, a digital television set, a computer, a mobile telephone, a digital radio set and a portable storage (for example, iPOD (registered trademark)). In the recording function field, information showing whether or not a function for storing the data of broadcast voice and images (a function for recording a broadcast program) is provided is stored. In the receiving function field, information showing whether a function for receiving broadcast voice and images (a function for receiving a broadcast program) is provided or not is stored. The above-mentioned contents stored in the device profile information table 700 are also called device profile information.

The recording reservation management table 750 stores information showing a schedule of the receiving and the recording of a broadcast program. The receiving device 100 receives a broadcast program according to a schedule stored in the recording reservation management table 750 and transmits it to the recording device 300. Besides, the receiving device 100 stores information showing a schedule for receiving voice and images in the recording reservation management table 750 based upon a request for receiving the broadcast program transmitted from the recording controller 200. As described above, if the start of recording and the termination of recording are instructed by the recording controller 200, the recording reservation management table 750 is not necessarily required to be stored in the main memory 120 of the receiving device 100.

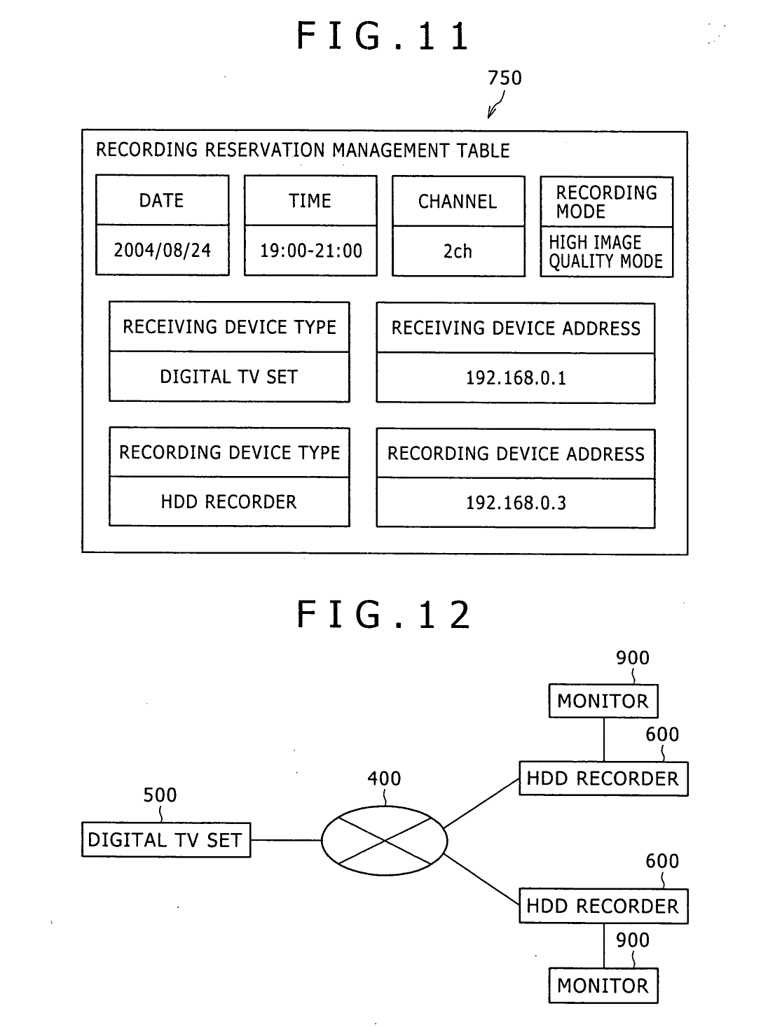

FIG. 11 shows one example of the recording reservation management table 750. As shown in FIG. 11, the recording reservation management table 750 is provided with a “date” field, a “time” field, a “channel” field, a “recording mode” field, a “receiving device type” field, a “receiving device address” field, a “recording device type” field and a “recording device address” field. As for the receiving device 100, the “receiving device type” field and the “receiving device address” field are not necessarily required to be provided. In the date field, information showing a date when a broadcast program is received and recorded is stored. In the time field, information showing start time and termination time at which the broadcast program is received and recorded is stored. In the channel field, information showing a channel of the broadcast program is stored. In the recording mode field, information showing a recording mode when the broadcast program is recorded is stored. In the receiving device type field, the type of the receiving device 100 that receives the broadcast program is stored. In the receiving device address field, an address of the receiving device 100 that receives the broadcast program is stored. In the recording device type field, the type of the recording device 300 that records the broadcast program is stored. In the recording device address field, an address of the recording device 300 that records the broadcast program is stored.

As described in relation to FIG. 2, the broadcast receiver 140 is a device such as a tuner for receiving a broadcast program.

Besides, the communication control unit 130 is a unit which communicates with the recording controller 200, the recording device 300 or another receiving device 100 via the network 400. The receiving device 100 transmits the data of voice and images received by the broadcast receiver 140 to the recording device 300 for example via the network 400 by means of the communication control unit 130.

<Recording Device>

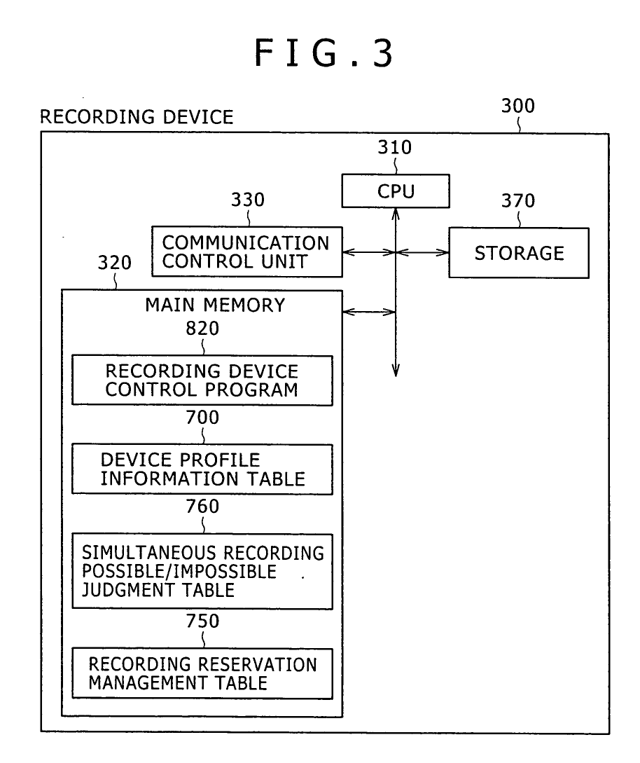

Next, the configuration of the recording device 300 will be described referring to FIG. 3.

The recording device 300 is provided with a CPU 310, a main memory 320, a communication control unit 330 and a storage (equivalent to the recording medium in the invention) 370.

The CPU 310 controls the whole recording device 300 and realizes various functions as the recording device 300 by executing a recording device control program 820 stored in the main memory 320 and configured by codes for enabling various operations in this embodiment. For example, when the CPU 310 executes the recording device control program 820 and collaborates with hardware equipment such as the main memory 320, the communication control unit 330 and the storage 370, a schedule memory unit, a data recording controlling unit, a simultaneous data recorded number transmitting unit, a data recording reserved number transmitting unit, a confirmation request receiving unit, a unit which determines whether recording is enabled or not, a response transmitting unit and a recording schedule addition controlling unit are realized.

The main memory 320 is used for a work area by the CPU 310 and stores the recording device control program 820, the device profile information table 700, a simultaneous recording possible/impossible judgment table 760 and the recording reservation management table 750. For example, the work area can be realized by RAM, and the above-mentioned program and tables can be realized by ROM.

The recording device control program 820 is a program for making the recording device 300 function. For example, the program is a program for executing control for receiving the data of a broadcast program from the receiving device 100 and recording it. The recording device control program 820 can also be configured by plural programs.

The device profile information table 700 is a table where information showing functions with which each device (the receiving device 100, the recording controller 200 and the recording device 300) configuring the data recording system is provided is stored as described above.

The simultaneous recording possible/impossible judgment table 760 is a table for judging whether simultaneous recording is enabled or not when plural broadcast programs are recorded in the storage 370. For example, if plural receiving devices 100 are connected to the network 400, a request to simultaneously record broadcast programs received by each receiving device 100 may be made to the specific recording device 300. In this case, if the request exceeds the throughput of the recording device 300, recording all is not possible. If a recording process that exceeds the throughput is tried, the so-called omission of the process and a hang-up may occur. Therefore, in case the recording device 300 in this embodiment receives a request to check whether the recording of a broadcast program is enabled or not from the recording controller 200, the recording device determines whether or not the recording is enabled or not and transmits a response to whether the recording is enabled to the recording controller 200 according to the result of the determination. The above-mentioned determination can be made by referring to the simultaneous recording possible/impossible judgment table 760.

FIG. 6 shows one example of the simultaneous recording possible/impossible judgment table 760. FIG. 6 shows a case that it is determined by respective image quality modes whether or not two recordings can be simultaneously made. That is, FIG. 6 shows that simultaneous recording is possible only if at least either of two recordings is in a high image quality mode. The above-mentioned simultaneous recording possible/impossible judgment table 760 can be stored in the main memory 320 of the recording device 300 in manufacturing for example. The image quality mode means a quality level of voice and images. The quality level of voice and images can be controlled by a data amount per unit time when data is recorded in the storage 370. That is, the quality of voice and a screen can be made lower by reducing the data amount per unit time. However, the quality cannot be made higher than the quality of voice and a screen received by the receiving device 100. Once recording is made in a state in which the quality of images is deteriorated, the quality of voice and a screen cannot be made higher than the image quality at that time. To deteriorate image quality and to reduce a data amount per unit time, an encoder described later is used. Therefore, if it exceeds the throughput of the recording device 300 to simultaneously deteriorate the quality of two voices and image data using the encoder, two recordings cannot be simultaneously made unless the high image quality mode is selected in two requests for recording as shown in FIG. 6.

The recording reservation management table 750 stores information showing a schedule of the receiving and the recording of a broadcast program as described above. The recording device 300 receives a broadcast program from the receiving device 100 according to a schedule stored in the recording reservation management table 750 and writes it in the storage 370. The recording device 300 stores information showing a schedule for recording voice and images in the recording reservation management table 750 based upon a request to record a broadcast program transmitted from the recording controller 200. The recording device 300 is not necessarily required to include a “recording device type” field and a “recording device address” field. As described above, if an instruction to start recording and an instruction to terminate recording are made by the recording controller 200, the recording reservation management table 750 is not necessarily required to be stored in the main memory 320 of the recording device 300.

The storage 370 is a device (recording medium) for recording the data of broadcast voice and images as described above.

The communication control unit 330 communicates with the recording controller 200, the receiving device 100 or another recording device 300 via the network 400. The recording device 300 receives the data of voice and images transmitted from the receiving device 100 via the network 400 by the communication control unit 330 and records the data in the storage 370.

<Recording Controller>

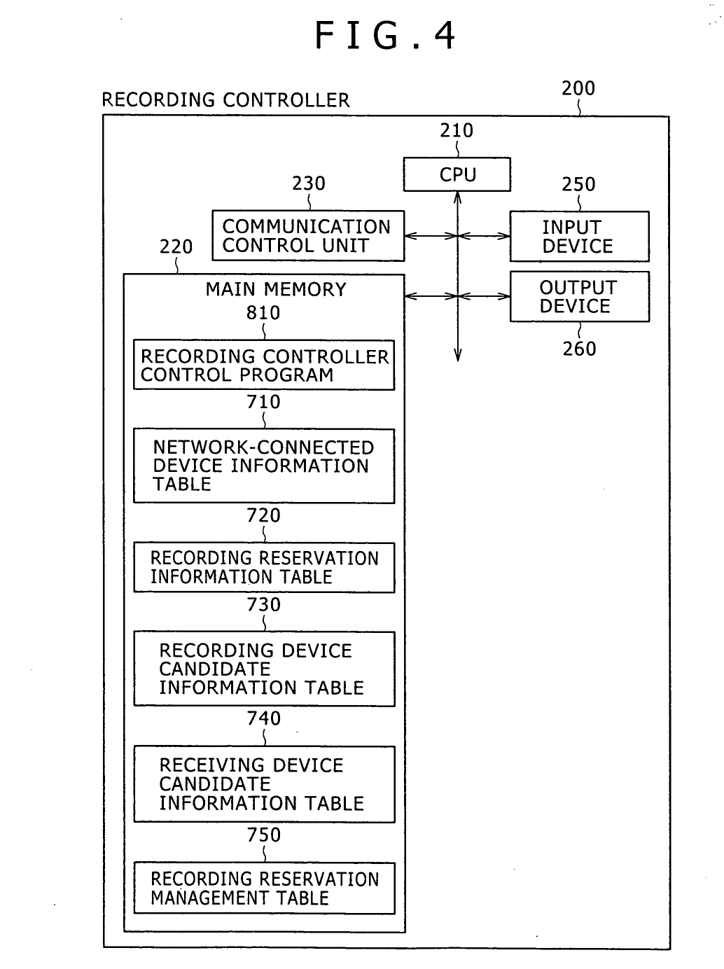

Next, the configuration of the recording controller 200 will be described referring to FIG. 4.

The recording controller 200 is provided with a CPU 210, a main memory 220, a communication control unit 230, an input device 250 and an output device 260.

The CPU 210 controls the whole recording controller 200 and realizes various functions as the recording controller 200 by executing a recording controller control program 810 stored in the main memory 220 and configured by codes for enabling various operations in this embodiment. For example, when the CPU 210 executes the recording controller control program 810 and collaborates hardware equipment such as the main memory 220, the communication control unit 230, the input device 250 and the output device 260, then a data recording reservation information input unit, a simultaneous data recording number receiving unit, a data recording reservation number receiving unit, a data recording device candidate memory unit, a memory capacity receiving unit, a data recording device selecting unit, a recording request transmitting unit, a confirmation request transmitting unit, a data recording device candidate selecting unit, a data recording device candidate memory unit, a data recording request information input unit, a receiving schedule receiving unit, a receiving device selecting unit and a receiving request transmitting unit are realized.

The main memory 220 is used for a work area by the CPU 210 and stores the recording controller control program 810, a network-connected device information table 710, a recording reservation information table 720, a recording device candidate information table 730, a receiving device candidate information table 740 and a recording reservation management table 750. For example, the work area can be realized by RAM, and the above-mentioned program and tables can be realized by ROM.

The recording controller control program 810 is a program for making the recording controller 200 function. For example, the recording controller control program accepts a reservation for recording input from a user interface and selects the receiving device 100 and the recording device 300. The recording controller control program 810 can also be configured by plural programs.

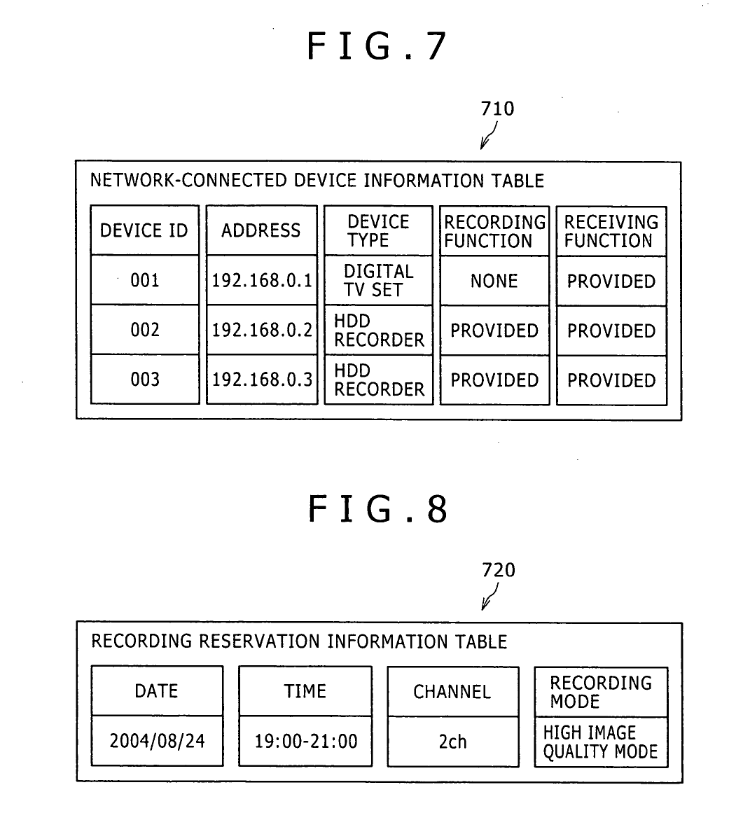

The network-connected device information table 710 stores information related to the receiving device 100, the recording device 300 and the recording controller 200 respectively connected to the network 400. FIG. 7 shows the network-connected device information table 710. The network-connected device information table 710 is provided with a “device ID” field, an “address” field, a “device type” field, a “recording device function” field and a “receiving device function” field. In the device ID field, an identification number (ID) conferred by the recording controller 200 to identify each device connected via the network 400 is stored. In the address field, the device type field, the recording device function field and the receiving device function field, the contents of the device profile information of each device which the recording controller 200 acquires from each device connected via the network 400 and which, for example, are stored in the device profile information table 700 are stored. The device profile information of each device can be acquired when the recording controller 200 transmits a control signal to request to transmit device profile information to all devices connected via the network 400 and receives the device profile information transmitted from each device connected via the network 400 in case a request to start recording control is input from a user to the recording controller 200 by remote control.

The recording reservation information table 720 stores data recording reservation information in which conditions in recording a broadcast program input from a user interface to the recording controller 200 are described. FIG. 8 shows the recording reservation information table 720. The recording reservation information table 720 is provided with a “date” field, a “time” field, a “channel” field and a “recording mode” field. In the date field, information showing a date when a broadcast program is recorded is stored. In the time field, information showing time at which the broadcast program is started and time at which it is terminated is stored. In the channel field, information showing a channel in which the broadcast program is broadcast is stored. In the recording mode field, information showing a recording mode (an image quality mode) when the broadcast program is recorded is stored.

The recording controller 200 transmits a request to confirm whether recording from recording start time to recording termination time respectively stored as data recording reservation information in the recording reservation information table 720 is enabled to the recording device 300 and selects a candidate of the recording device 300 for recording a broadcast program from the recording start time to the recording termination time as the data recording reservation information according to the result of a response from each recording device 300 for the request to confirm. For example, the recording controller selects the recording device 300 that transmits a response that recording from the recording start time to the recording termination time is enabled as a candidate of the recording device 300 for recording a broadcast program from the recording start time to the recording termination time respectively stored as the data recording reservation information. Needless to say, the recording device 300 that does not transmit a response that recording from the recording start time to the recording termination time is not enabled can also be selected as a candidate of the recording device 300 that records a broadcast program from the recording start time to the recording termination time respectively stored as the data recording reservation information. The identification information of the selected recording device 300 is stored in the recording device candidate information table 730.

Although the details will be described later, the recording controller 200 receives information showing the number of the data of voice and images which each recording device 300 can simultaneously write in each storage 370 and information showing the number of the data of voice and images which each recording device 300 is scheduled to write in each storage 370 from the recording start time to the recording termination time respectively stored as the data recording reservation information from each recording device 300, compares the number of the data of voice and images which can be simultaneously written with the number of the data of voice and images which is scheduled to be written in the storage 370 from the recording start time to the recording termination time in relation to each recording device 300, and can also select the recording device in which the number of the data of voice and images which is scheduled to be written in the storage 370 from the recording start time to the recording termination time is smaller than the number of the data of voice and images which can be simultaneously written as a candidate of the recording device 300 that records from the recording start time to the recording termination time. The identification information of the selected recording device 300 is stored in the recording device candidate information table 730.

The comparison of the number of the data of voice an image which can be simultaneously written and the number of the data of voice and images which is scheduled to be written in the storage 370 from the recording start time to the recording termination time can also be made in each recording device 300. In this case, each recording device 300 receives a request to confirm whether recording from the recording start time to the recording termination time respectively stored as the data recording reservation information is enabled or not from the recording controller 200, determines that the recording of the data of voice and images from the recording start time to the recording termination time is enabled in case the number of the data of voice and images which is scheduled to be written in the storage 370 from the recording start time to the recording termination time is smaller than the number of the data of voice and image which can be simultaneously written in the storage 370, and transmits a response of whether the recording of the data of voice an images from the recording start time to the recording termination time is enabled to the recording controller 200 according the result of the determination.

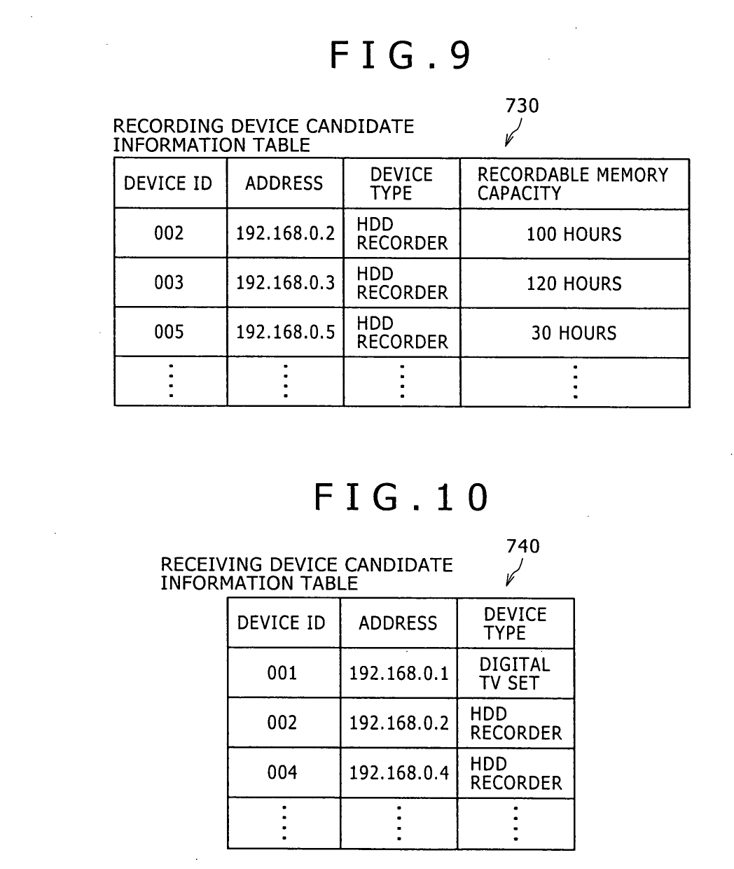

The recording device candidate information table 730 stores a candidate of the recording device 300 selected as described above. FIG. 9 shows the recording device candidate information table 730. The recording device candidate information table 730 is provided with a “device ID” field, an “address” field, a “device type” field and a “recordable memory capacity” field.

In the recordable memory capacity field, information showing the free memory capacity of each storage 370 with which a candidate of each recording device 300 is provided is stored. The information is transmitted from each recording device 300 selected as the candidate to the recording controller 200. Though the details will be described later, the recording controller 200 can select the recording device provided with the storage 370 having the largest free memory capacity out of each candidate as the recording device 300 that records a broadcast program.

The receiving device candidate information table 740 stores a candidate of the receiving device 100 that receives a broadcast program. A candidate of the receiving device 100 that receives a broadcast program is selected when the recording controller control program 810 is executed. FIG. 10 shows the receiving device candidate information table 740. The receiving device candidate information table 740 is provided with a “device ID” field, an “address” field and a “device type” field. The recording controller 200 instructs the receiving device 100 selected out of these candidates to receive a broadcast program. The details will be described later.

The recording reservation management table 750 stores information showing a schedule of the receiving and the recording of a broadcast program as described above.

The communication control unit 230 communicates with another recording controller 200, the receiving device 100 or the recording device 300 via the network 400.

The input device 250 is used for the input of data to the recording controller 200 and functions as a user interface. For the input device 250, for example, a control switch, a touch panel, a remote control or a keyboard and a mouse can be used.

The output device 260 is a device for outputting information to an external device and functions as a user interface. For the output device 260, for example, a display and a buzzer can be used.

<Network>

For the network 400, Ethernet (a trademark) and wireless local area network (LAN) and IEEE 1394 are used. That is, between respective devices connected via the network 400, data can be communicated according to the above-mentioned predetermined procedure. The network 400 may be a network (a user's network) configured inside a home and inside a building.

### Embodiment Applied to Digital Television Set and HDD Recorder

Next, an embodiment in case each receiving device 100, the recording controller 200 and each recording device 300 are applied to a more concrete system will be described. In this case, an example will be described in a case where the receiving device 100 and the recording controller 200 are configured by a digital television set 500 and the recording device 300 is configured by a HDD recorder 600.

Needless to say, as described above, each receiving device 100, the recording controller 200 and each recording device 300 can also be configured by other various devices. For example, the receiving device 100 can be configured by a HDD recorder provided with the broadcast receiver 140, a DVD recorder, an analog television set, a digital radio, an analog radio, a mobile telephone and a personal computer. The recording device 300 can be configured by a DVD recorder provided with the storage 370, a personal computer, a portable storage and a digital television set. The recording controller 200 can be configured by a HDD recorder, a DVD recorder, a digital television set and a personal computer. Therefore, in a data recording system in which plural HDD recorders are connected via the network 400, any HDD recorder can also function as the receiving device 100, can also function as the recording controller 200, and can also function as the recording device 300.

FIG. 12 shows an example of the configuration of the data recording system to which a recording method via the network 400 in this embodiment can be applied.

As shown in FIG. 12, in the data recording system in this embodiment, the digital television set 500 and the HDD recorder 600 are connected via the network 400 so that they can communicate. The network 400 is a user's network using a wire circuit or by radio.

A monitor 900 is connected to a HDD recorder 600. The monitor 900 is connected to the HDD recorder 600 via an audio visual (AV) cable and is provided with a function for displaying an image output by the HDD recorder 600.

The network 400 is a network using Ethernet (registered trademark), wireless LAN and IEEE 1394 and enables devices connected to the network 400 to communicate data with each other according to the predetermined procedure.

<Digital Television Set>

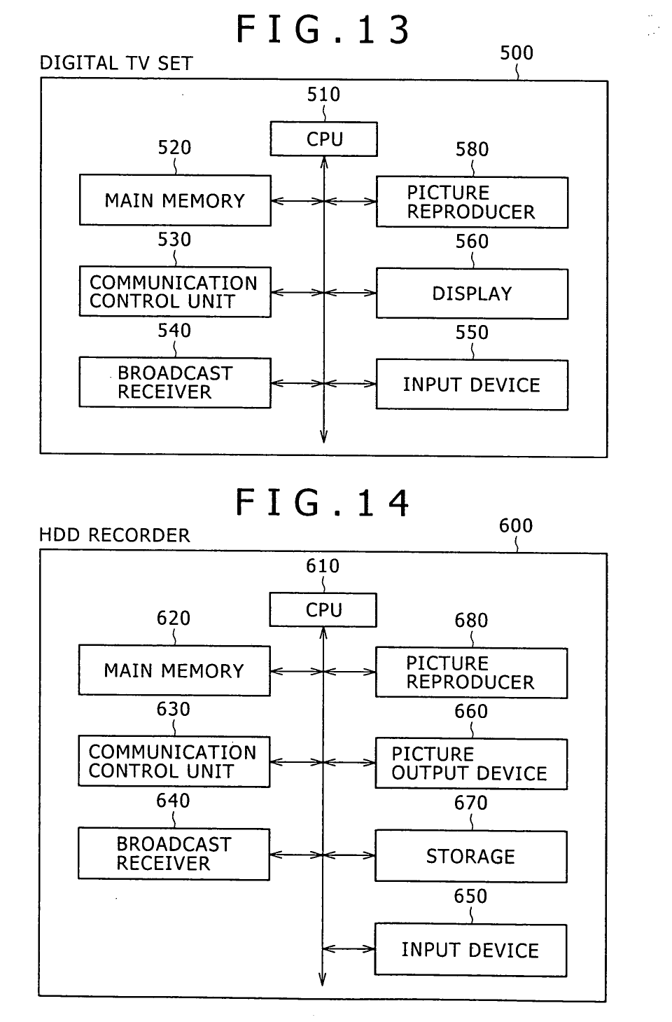

FIG. 13 is a block diagram showing the digital television set 500 to which this embodiment can be applied.

The digital television set 500 is provided with a CPU 510, a main memory 520, a communication control unit 530, a broadcast receiver 540, a picture reproducer 580, a display 560 and an input device 550. Each component is connected via a bus and is configured so that information required between each component can be transmitted.

The CPU 510 executes predetermined operation according to a program stored in the main memory 520 beforehand.

The main memory 520 is means for functioning as a work area and storing required programs, for example, the work area can be realized by RAM, and the required programs can be realized by ROM.

The communication control unit 530 is equivalent to the above-mentioned communication control units 130, 230 and 330. That is, the communication control unit is means for transmitting and receiving information (data) with another device via the network 400. The communication control unit 530 is realized by a network adaptor and a radio transmitter-receiver for example.

The broadcast receiver 540 is equivalent to the above-mentioned broadcast receiver 140. That is, the broadcast receiver 540 is means for receiving digital satellite broadcasting, digital ground-based broadcasting or digital CATV broadcasting. For the digital satellite broadcasting, there are digital CS broadcasting and digital BS broadcasting respectively already applied in Japan and for the digital ground-based broadcasting, there is digital ground-based broadcasting already applied in Japan. In this embodiment, the broadcast receiver is described as a receiver for the digital ground-based broadcasting, however, needless to say, the invention is not limited to digital ground-based broadcasting. Further, the broadcast receiver 540 may also be configured so that it can receive plural broadcast formats.

The picture reproducer 580 decompresses (decodes) a picture and transmits the decoded picture to the display 560.

The display 560 is equivalent to the above-mentioned output device 260. The display 560 is means for displaying a picture decompressed (decoded) by the picture reproducer 580 and information for responding to a user's operations. The display 560 can be realized by a cathode ray tube, a liquid crystal display, a PDP, a projector, a speaker, a headphone and others.

The input device 550 is equivalent to the above-mentioned input device 250. The input device 550 is means for a user to input required instruction and information to the digital television set 550 and can be realized by remote control.

If a device not directly related to the input-output of data and a program is included in the digital television set 500, the device can be omitted.

<HDD Recorder>

FIG. 14 is a block diagram showing the HDD recorder 600 to which this embodiment can be applied.

The HDD recorder 600 is provided with a CPU 610, a main memory 620, a communication control unit 630, a broadcast receiver 640, a picture reproducer 680, a picture output device 660, a storage 670 and an input device 650. Each component is connected via a bus and is configured so that required information can be transmitted between each component.

The CPU 610 executes predetermined operation according to a program stored in the main memory 620 and the storage 670 beforehand.

The main memory 620 is means for functioning as a work area and storing a required program, for example, the work area can be realized by RAM, and the program can be realized by ROM.

The communication control unit 630 is equivalent to the above-mentioned communication control units 130, 230 and 330. That is, it is means for transmitting and receiving information (data) with another device via the network 400. The communication control unit 630 is realized by a network adaptor and a radio transmitter-receiver for example.

The broadcast receiver 640 is equivalent to the above-mentioned broadcast receiver 140. That is, the broadcast receiver 540 is means for receiving digital satellite broadcasting, digital ground-based broadcasting or digital CATV broadcasting. For the digital satellite broadcasting, there are digital CS broadcasting and digital BS broadcasting respectively already applied in Japan and for the digital ground-based broadcasting, there is digital ground-based broadcasting already applied in Japan. In this embodiment, the broadcast receiver 640 is described as a receiving device for digital ground-based broadcasting, however, needless to say, the invention is not limited to digital ground-based broadcasting. Further, the broadcast receiver 640 may also be configured so that it can receive plural broadcast formats.

The picture reproducer 680 decompresses (decodes) a picture and transmits the decoded picture to the picture output device 660.

The picture output device 660 is equivalent to the above-mentioned output device 260. The picture output device 660 is connected to a monitor 900 via an AV cable and outputs a picture decoded by the picture reproducer 680.

The storage 670 is equivalent to the above-mentioned storage 370. The storage 670 is means for storing a program for controlling the operation of the HDD recorder 600 and storing a picture received by the communication control unit 630 and a picture received by the broadcast receiver 640 and recorded, and can be realized by a hard disk and an optical disk for example.

The input device 650 is equivalent to the above-mentioned input device 250. The input device 650 is means for a user to input required instruction and information to the HDD recorder 600 and can be realized by a remote control.

If a device not directly related to the input-output of data and a program is included in the HDD recorder 600, the device can also be omitted.

=== Flow of Recording Reservation Process ===

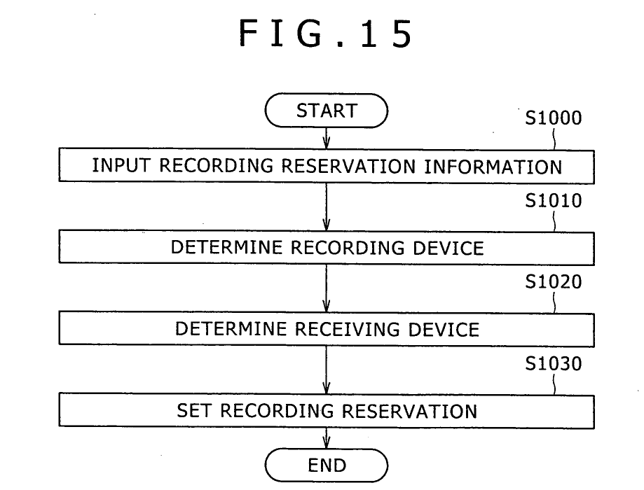

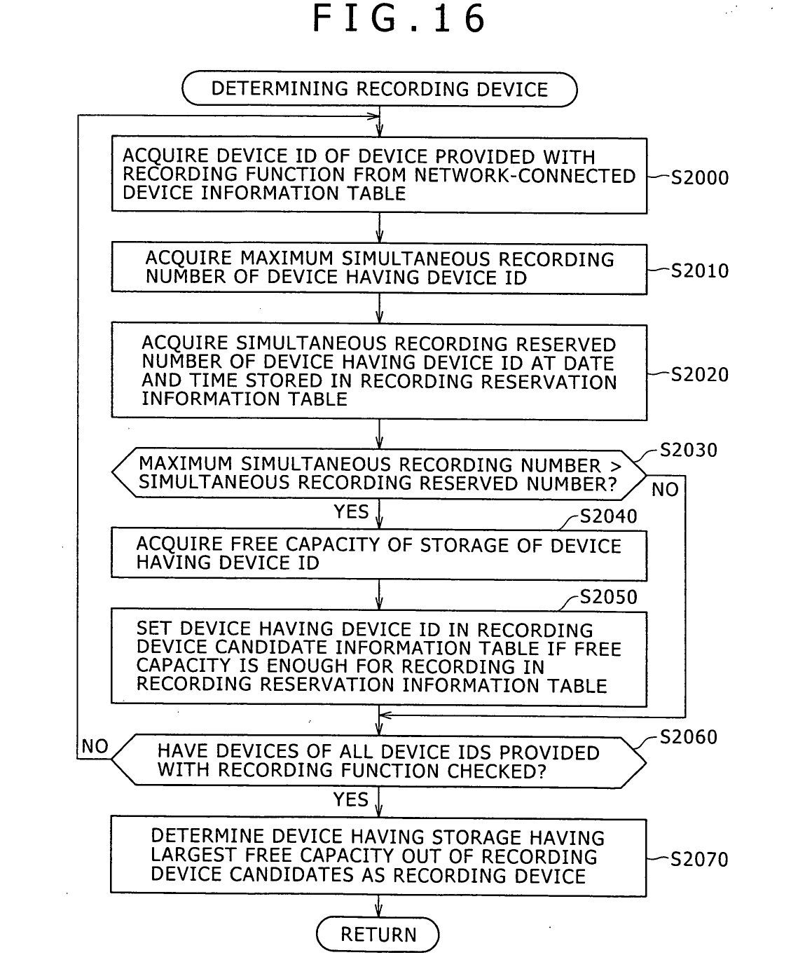

Next, the flow of a recording reservation process in this embodiment will be described referring to a flowchart shown in FIG. 15.

FIG. 15 is a flowchart showing a procedure after a user starts recording reservation until the recording reservation is set in the recording reservation in this embodiment. In the recording reservation in this embodiment, a user inputs recording reservation information, a unit connected to the network 400 determines a system provided with the storage 670 for recording and a system provided with the broadcast receiver 540 for receiving broadcast data based upon the information, and sets recording reservation.

In this embodiment, as shown in FIG. 15, a unit (a recording controller 200) for displaying information required by a user, accepting input from the user and controlling recording reservation is described as the digital television set 500, however, the recording controller 200 may also be the HDD recorder 600. If the recording controller 200 is the HDD recorder 600, the HDD recorder 600 displays information required by the user on the monitor 900 via the picture output device 660.

Each device to which a recording method in this embodiment is applied stores the device profile information table 700 shown in FIG. 5 for example to make mutually required communication with via the network 400. In this case, the device profile information table 700 includes an address showing the location on the network of a device, a device type showing the type of the device such as a digital television set and a HDD recorder and information showing whether a recording function in the recording method in this embodiment or a receiving function is provided for example. Universal information for a device such as the type of the device, the recording function or the receiving function in the device profile information table 700 is stored beforehand in the shipment of the device or in the installation of a program for controlling the recording method in this embodiment in the device. As for the address, a user arbitrarily sets an address and stores it in the device or a router not shown in the system configuration shown in FIG. 12 automatically allocates an address using technique such as a dynamic host configuration protocol when the device is activated or when the device is connected to the network 400. The address is also allocated by a method of storing the following address if the device arbitrarily declares its own address when the device is activated or when the device is connected to the network 400 and the address does not compete with another device connected to the network 400.

The recording controller 200 stores the network-connected device information table 710 shown in FIG. 7 for example to communicate information with each device connected to the network 400. The network-connected device information table 710 includes information such as a device ID, an address, a type of a device, a recording function and a receiving function. The device ID means a number (ID) arbitrarily conferred by the recording controller 200 to specify each equipment piece connected to the network 400, and the address, the type of the device, the recording function and the receiving function mean the contents of the device profile information of each device acquired from each device by the recording controller 200 and stored in the device profile information table 700 for example.

Network-connected device information stored in the network-connected device information table 710 is generated when the recording controller 200 acquires the device profile information of each device connected to the network 400. For example, when the recording controller 200 transmits a control signal to request the device profile information of all devices connected to the network 400 when a request to start recording control is input from a user to the recording controller 200 using a remote control and others, the recording controller 200 acquires the device profile information of each device connected to the network and can generate each pieces of network-connected device information stored in the network-connected device information table 710.

The recording reservation in this embodiment shown in FIG. 15 will be described in detail below.

The recording controller 200 for executing the recording reservation shown in FIG. 15 of the digital television set 500 and others starts recording reservation by remote input such as “start recording reservation” for example from a user.

<Recording Reservation Information Input Process>

When recording reservation is started, the recording controller 200 first outputs a recording reservation information input screen and accepts data shown in the recording reservation information table 720 shown in FIG. 8 for example as recording reservation information from a user (S1000). The recording reservation information table 720 includes a date, time, a channel and a recording mode for example. The recording mode denotes the quality of recording, includes a high image quality mode, a normal mode and a low image quality mode for example, and the high image quality mode requires a large data amount for recording, compared with the low image quality mode. The recording controller 200 to which recording reservation information shown in the recording reservation information table 720 is input from a user stores the recording reservation information in a work area and others The recording controller 200 calculates a data amount required for recording defined in the recording reservation information based upon time and a recording mode in the recording reservation information and stores it in the work area and others.

<Recording Device Determination Process>

Next, the recording controller 200 determines the recording device 300 for recording defined in the recording reservation information (S2000).

FIG. 16 is a flowchart showing the details of a procedure for determining the recording device S1010.

First, the recording controller 200 searches a device provided with a recording function from network-connected device information stored in the network-connected device information table 710 and acquires the ID of the device provided with the recording function (S2000).

Next, the recording controller 200 acquires the maximum simultaneous recording number of the device having the device ID (S2010). The maximum simultaneous recording number means the number of the data of voice and images which each recording device 300 can simultaneously write in each storage 370 and means the number of recording in which the device can simultaneously execute a recording process without causing a problem such as failure of the process and a hang-up.

The maximum simultaneous recording number is determined by the performance of the device such as the performance of a CPU (the throughput of the CPU), the writing speed to the storage of a HDD and others, the number of parallel simultaneous processes by an encoder (the throughput of the encoder) and a network band (transmission speed when the data of voice and images is transmitted from the receiving device to the recording device). In a device provided with a recording function to which the recording method in this embodiment can be applied, the maximum simultaneous recording number is set (stored) beforehand as information proper to the device in the shipment of the device or can be calculated or derived based upon/from the performance of the device such as the performance of the CPU, the writing speed to the storage, the simultaneous processing number by the encoder and the network band, and can be responded in response to a request of the recording controller 200.

For a method of calculating or deriving the maximum simultaneous recording number based upon/from the performance of the device, the following method exists.

First, a simultaneous recording number for the performance of the CPU of the device, the writing speed to the storage, the simultaneous processing number by the encoder and the network band is acquired or calculated.

As for the performance of the CPU, the increasing rate (a value A) of a load of the CPU increasing in one recording process and a rate (a value B) of the performance of the CPU which the device can use for the recording process are acquired and an integral part (C=|B/A|, however, |X| denotes an integral part of a number X) of an answer acquired by dividing the value B by the value A can be regarded as a simultaneous recording number related to the performance of the CPU.

As for the writing speed to the storage, when the writing speed to the storage of the device is D bits per second (bps) at the maximum and the bit rate of a high-vision picture is E bps, an integral part (F=|D/E|) of an answer acquired by dividing D by E is equivalent to a simultaneous recording number related to the writing speed to the storage. This means that the device can simultaneously process by F (the number of recording) even if all data simultaneously recorded consists of high image quality high-vision pictures.

As for the simultaneous processing number of the encoder, if the simultaneous processing number of the encoder is G, it can be regarded as a simultaneous processing number related to the simultaneous processing number of the encoder.

As for a network band, when the network band of the device is H bps and the bit rate of a hi-vision picture is I bps, an integral part (J=|H/I|) of an answer acquired by dividing H by I can be regarded as a simultaneous recording number related to the network band. This means that the device can simultaneously process by J (the number of recording) even if all data simultaneously recorded consists of high image quality high-vision pictures.

In this case, the maximum simultaneous recording number shall be the smallest number of the simultaneous recording numbers acquired above and related to each performance of the device, that is, C, F, G and J. The reason is that performance that causes the smallest number of C, F, G and J ends in a bottleneck of the simultaneous recording numbers of the device.

Needless to say, the smallest value of C, F, G and J is not adopted as the maximum simultaneous recording number but the maximum simultaneous recording number can also be determined by any of these values or the smallest value in the combination of two or more of these values. For example, in a device provided with no encoder, the smallest value of C, F and J can be adopted.

Next, the recording controller 200 acquires the simultaneous recording reserved number of a device having device ID at a date and time in recording reservation information stored in the recording reservation information table 720 (S2020). The simultaneous recording reserved number means the number of the data of voice and images which each recording device 300 is scheduled to write in each storage 370 from recording start time stored in the recording reservation information (data recording reservation information) to recording termination time, that is, the maximum number of reserved recording simultaneously made in a time zone shown by the date and the time in the recording reservation information. For example, if the reservation of recording from 18:00 in the evening to 20:00 in the evening of the same day, the reservation of recording from 19:00 in the evening to 20:30 in the evening of the same day and the reservation of recording from 19:30 in the evening to 20:30 in the evening of the same day are already set in a certain device provided with a recording function when recording reservation information is input to set the reservation of recording from 19:00 in the evening to 21:00 in the evening of Aug. 24, 2004, three reservations of recording are already simultaneously set from 19:30 in the evening to 20:00 in the evening. Therefore, the simultaneous recording reserved number in this case is 3.

Next, the acquired maximum simultaneous recording number and the simultaneous recording reserved number are compared (S2030). If the simultaneous recording reserved number is smaller than the maximum simultaneous recording number, the recording controller 200 acquires the free capacity (the free memory capacity) of the storage of the device specified by the device ID (S2040) and if the free capacity is enough to record according to the recording reservation information, the recording controller sets such as stores a name of the device specified by the device ID as a recording device candidate in a work area (S2050). The storage of the recording device candidate may also be performed before the free capacity of the storage is checked and a device having the largest free capacity of each candidate can also be selected as a recording device. A storage region of the storage 670 of each HDD recorder 600 can be effectively used by selecting the device the storage of which has the largest free capacity as the recording device 300 as described above.

When each procedure of S2000 to S2030 and a procedure of S2040 and S2050 according to circumstances are made for devices having any device ID (S2060), the device having the largest free capacity for example out of the devices having the device ID set as the recording device candidate in S2050 is determined as the recording device (S2070).

There exists the possibility that plural recordings are simultaneously made in a specific recording device in recording via a network. At this time, there exists the possibility that the reservation of recording concentrates in a device having a storage having the largest capacity out of devices on the network exists and when the reservation of recording concentrates, and there also exists the possibility that recording fails because of the omission of the processing of the recording device or a hang-up even if the storage has enough free capacity.

In the recording method in this embodiment, after it is verified that a simultaneous recording reserved number is smaller than a maximum simultaneous recording number, a recording device is determined. Therefore, recording can be prevented from failing because of a problem such as the recording device fails in processing in recording or is hung up by reason of the performance of the CPU, the writing speed to a storage, the simultaneous processing number of an encoder or the shortage of the performance of the device such as a network band in recording.

### Another Embodiment of Recording Device Determination Process>

In the above-mentioned reservation of recording, as shown in FIG. 16, when the recording controller 200 verifies that a simultaneous recording reserved number is smaller than a maximum simultaneous recording number and determines a recording device, it is prevented that the reservation of recording that exceeds the throughput of the following device concentrates in a specific recording device and recording fails.

This process is also enabled when the recording controller 200 inquires of each recording device 300 whether recording is possible or not.

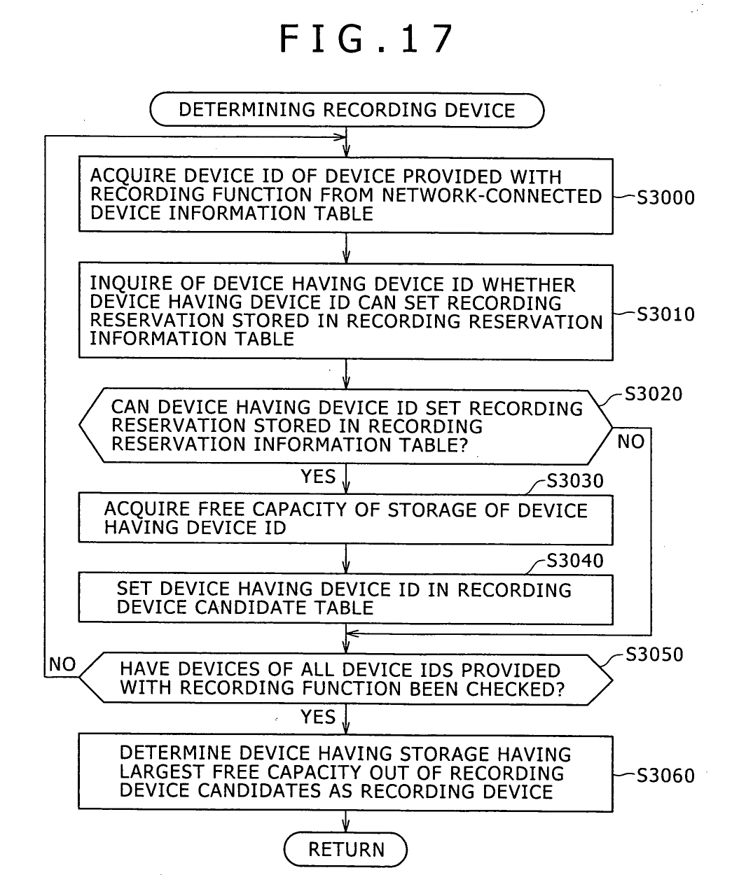

FIG. 17 is a flowchart showing the procedure for determining the recording device S1010 in detail.

First, the recording controller 200 checks a device having a recording function based upon network-connected device information stored in the network-connected device information table 710 and acquires the device ID of the device having the recording function (S3000).

Next, the recording controller 200 inquires of the device having the device ID whether the device having the device ID can set the reservation of recording in recording reservation information stored in the recording reservation information table 720 (S3010). That is, the recording controller 200 transmits at least recording reservation possible/impossible judgment information including the recording reservation information stored in the recording reservation information table 720 to the device having the device ID, the device having the device ID judges whether the device having the device ID can set the reservation of recording in the recording reservation information included in the recording reservation possible/impossible judgment information based upon the recording reservation information included in the received recording reservation possible/impossible judgment information, and transmits the answer to the recording controller.

The judgment of whether the device having the device ID can set the reservation of recording in the recording reservation information included in the recording reservation possible/impossible judgment information and stored in the recording reservation information table 720 can be made as follows for example.

First, the device having the device ID acquires the maximum simultaneous recording number of the device having the device ID. The maximum simultaneous recording number means a recording number in which the device can simultaneously record without causing a problem such as the omission of processing and a hang-up and is determined by the performance of the CPU of the device, the writing speed to a storage of the HDD and others, the parallel simultaneous processing number of an encoder or the performance of the device such as a network band. In a device having a recording function to which the recording method in this embodiment can be applied, the maximum simultaneous recording number is set (stored) beforehand as information proper to the device in shipment or can be calculated or derived based upon/from the performance of the CPU of the device, the writing speed to the storage, the simultaneous processing number of the encoder or the performance of the device such as a network band.

Next, the device having the device ID acquires the simultaneous recording reserved number of the device having the device ID at a date and time in recording reservation information included in the recording reservation possible/impossible judgment information and stored in the recording reservation information table 720.

The device having the device ID compares the acquired maximum simultaneous recording number with the simultaneous recording reserved number and if the simultaneous recording reserved number is smaller than the maximum simultaneous recording number, the device transmits that the reservation of recording in the recording reservation information included in the recording reservation possible/impossible judgment information and stored in the recording reservation information table 720 can be set to the recording controller 200. Otherwise, the device transmits a message that the setting is impossible.

To judge whether the device having the device ID can set the reservation of recording in the recording reservation information included in the recording reservation possible/impossible judgment information and stored in the recording reservation information table 720, the following method can also be used.

First, the device having the device ID acquires all the reservations of recording already set in the device having the device ID at a date, time and the same time zone in the recording reservation information included in the recording reservation possible/impossible judgment information and stored in the recording reservation information table 720, referring to the recording reservation management table 750. In the device having the device ID, the simultaneous recording possible/impossible judgment table 760 shown in FIG. 6 for example is stored beforehand. In the simultaneous recording possible/impossible judgment table 760 shown in FIG. 6, elements in a row show the reservation of recording already set in the device having the device ID and elements in a column show recording reservation information to be set. For example, if the reservation of recording of which the recording mode is a low image quality mode is already set at a date and time in the recording reservation information included in the recording reservation possible/impossible judgment information and stored in the recording reservation information table 720 in the device having the device ID, the device having the device ID transmits a message that it can set the reservation of recording in the recording reservation information included in the recording reservation possible/impossible judgment information and stored in the recording reservation information table 720 to the recording controller 200 when the recording mode of the recording reservation information included in the recording reservation possible/impossible judgment information and stored in the recording reservation information table 720 is a high image quality mode. If the recording mode of the recording reservation information included in the recording reservation possible/impossible judgment information and stored in the recording reservation information table 720 is a normal mode or the low image quality mode, the device transmits that the reservation of recording cannot be set.

A description has been made of a case where in the simultaneous recording possible/impossible judgment table 760 shown in FIG. 6, only two reservations of recording at the maximum can be simultaneously set. Needless to say, however, if three or more reservations of recording can be simultaneously set in the device having the device ID, such a table may also be generated.

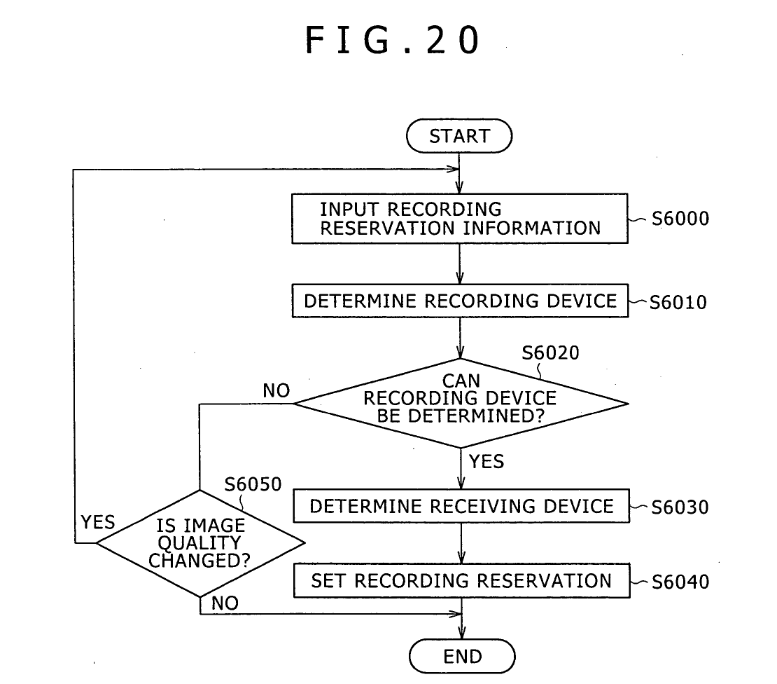

The recording controller 200 can also execute the process for inputting recording reservation information shown in S1000 again if the recording controller receives information that the reservation of recording cannot be set from each recording device 300. FIG. 20 shows a flowchart in that case. Hereby, a user can reserve recording again after he/she changes a condition for image quality.

<Receiving Device Determination Process>

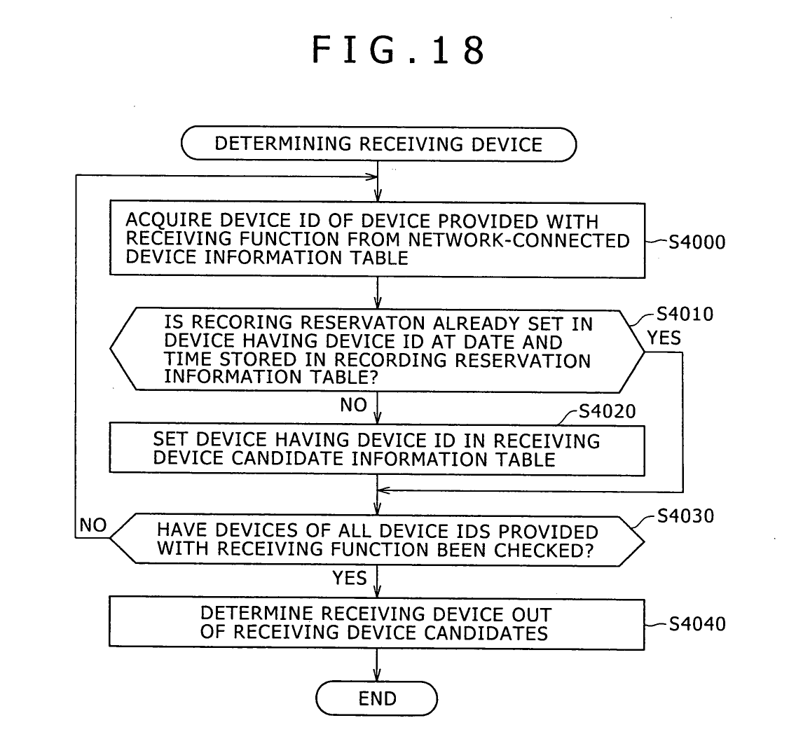

Next, the recording controller 200 executes a procedure for determining a receiving device in S1020 shown in FIG. 15. The recording device means a device for receiving broadcast data when reserved recording is made and transmitting it to the recording device determined according to the procedure in FIG. 18 is a flowchart showing the procedure for determining a receiving device in detail.

First, the recording controller 200 searches a device provided with a receiving function based upon the network-connected device information stored in the network-connected device information table 710 and acquires device ID of the device provided with the receiving function (S4000).

Next, the recording controller 200 checks whether the reservation of recording is already set in the device having the device ID at a date and time in the recording reservation information stored in the recording reservation information table 720 (S4010). That is, the recording controller compares the date and the time in the recording reservation information with a date and time of the reservation of recording already set in the device having the device ID and checks whether a broadcast receiver to receive can be used in the device having the device ID at the date and the time in the recording reservation information.

If the reservation of recording is not set yet in the device having the device ID at the date and the time stored in the recording reservation information, the recording controller 200 sets the device having the device ID as a receiving device candidate such as stores it in a work area (S4020).

When devices having all device IDs provided with a receiving function are checked in S4000, S4010 and S4020 according to circumstances (S4030), a receiving device is determined out of set receiving device candidates (S4040).

To determine the receiving device out of the receiving device candidates, any priority of receiving devices is used and the device having higher priority is selected as a receiving device. For example, the HDD recorder 600 is set to higher priority than the priority of the digital television set 500 the broadcast receiver 140 of which may be used for a user to look at television, a device having the same device ID as a device determined as a recording device is set to higher priority to omit labor for transmitting data to the network 400, and the receiving device is determined.

<Recording Reservation Setting Process>

When the receiving device is determined, the reservation of recording is set in S1030 shown in FIG. 15.

In a recording reservation setting process S1030, the recording controller 200 sets the reservation of recording including the contents of recording reservation information stored in the recording reservation information table 720 in the device 300 determined as a recording device, in the device 100 determined as a receiving device or in the recording controller 200. Recording reservation includes information such as a date to be recorded, time to be recorded, a recorded channel, a recording mode, a type of a receiving device, an address of the receiving device, a type of a recording device and an address of the recording device. Of the information included in the recording reservation, the date to be recorded, the time to be recorded, the recorded channel and the recording mode are acquired from recording reservation information stored in the recording reservation information table 720 stored in the recording controller 200. The type of the receiving device, the address of the receiving device, the type of the recording device and the address of the recording device are acquired from network-connected device information stored in the network-connected device information table 710 stored in the recording controller 200.

Of the information included in the recording reservation, information not required by a device (the receiving device 100 or the recording device 300) for recording reservation to be set can be omitted. For example, if recording reservation is set in the recording device 300, the type and the address of the recording device can be omitted.

The recording controller 200 adds information (for example, a type of a device or its address included network-connected device information stored in the network-connected device information table 710) related to the recording device 300 and the receiving device 100 to the date, the time, the channel and the recording mode respectively included in recording reservation information if necessary, generates recording reservation, and sets (stores) it in the device 300 determined as a recording device, the device 100 determined as a receiving device or the recording controller 200.

The device in which the recording reservation is set monitors time by a timer (not shown) owned inside, controls the recording device or the receiving device when time for the recording reservation comes, receives the broadcast data of the set channel, and makes recording, encoding the data again in accordance with the set recording mode if necessary. At this time, a procedure for encoding again is made in the recording device or in the receiving device.

Manual Recording Process

The recording method in this embodiment can be applied not only to recording reservation but to manual (immediate) recording.

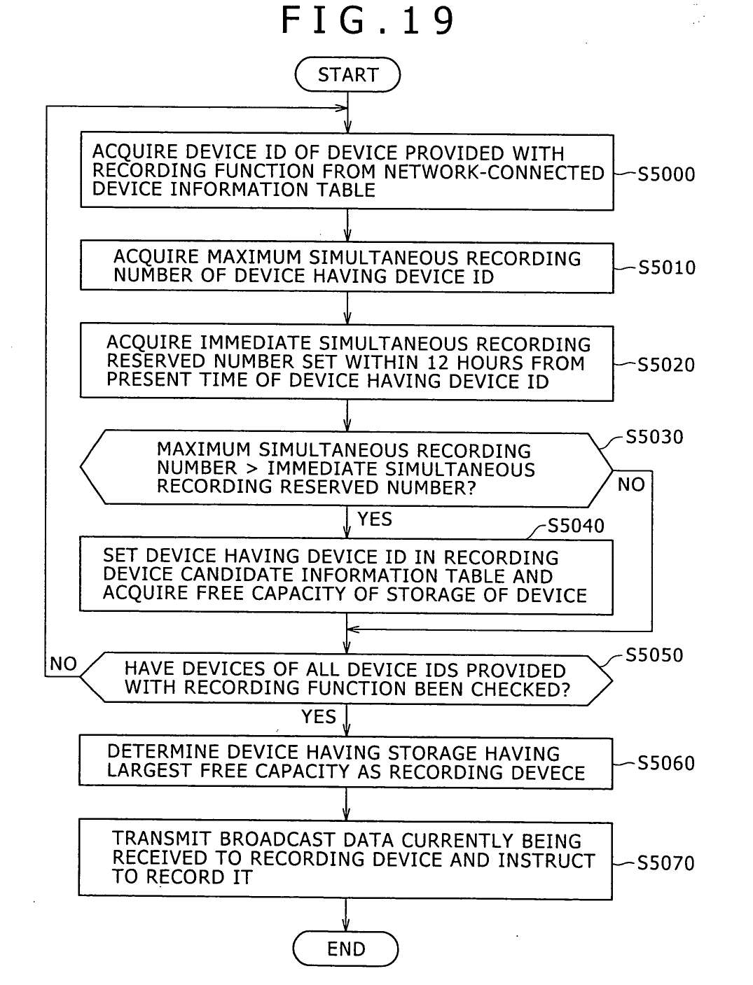

FIG. 19 is a flowchart showing a process when manual recording in this embodiment is made. The flowchart shown in FIG. 19 shows a procedure after a user makes a request to start manual recording until recording is started.

In this case, a case where the digital television set 500 is the recording controller 200 that receives input from the user and controls recording will be described, however, the HDD recorder 600 may also be the recording controller 200.

For example, when a user who looks at a television program provided by the digital television set 500 requests manual recording by operation such as pressing a recording button of a remote control, manual recording in this embodiment is started. At this time, the digital television set 500 functions as the recording controller 200, controls another device connected to the network 400, and performs manual recording.

First, for a premise, as manual recording is operation for recording the currently watched television program, a receiving device for receiving broadcast data in the manual recording shall be the broadcast receiver 540 that is receiving the currently watched broadcast data.

When a user who is watching a television program presses a recording button of a remote control, a manual recording request (data recording request information) is transmitted to the recording controller 200. Hereby, the recording controller 200 receives the input of the data recording request information in which conditions in recording a broadcast program at least including information showing a request for recording the broadcast program being received are described from a user interface.

Then, the recording controller 200 acquires the device ID of a device provided with a recording function from network-connected device information stored in the network-connected device information table 710 (S5000).

Next, the recording controller acquires the maximum simultaneous recording number of the device having the device ID (S5010).

In the case of manual recording, since recording termination time is not specified, it is unknown low long recording is to be made unlike reserved recording. Therefore, the recording controller 200 acquires a simultaneous recording reserved number (an immediate simultaneous recording reserved number) set in the device having the device ID for a certain period (for example, within 12 hours) from the present time (S5020).

The recording controller compares the immediate simultaneous recording reserved number with the maximum simultaneous recording number and when the immediate simultaneous recording reserved number is smaller than the maximum simultaneous recording number (S5030), the recording controller selects the device having the device ID as a recording device candidate and acquires the free capacity of a storage of the device (S5040).

Next, it is checked whether the procedures in S5000 to S5030 and S5040 according to circumstances are checked for devices of all device IDs provided with a recording function or not (S5050) and in case checks for the devices of all device IDs are finished, the device having a storage having the largest free capacity out of the devices set as recording device candidates is determined as a recording device (S5060).

Finally, the broadcast data of a channel being currently watched by a user is transmitted to the determined recording device and recording is started (S5070). The storage of a recording device candidate can also be executed before the free capacity of the storage is checked.

This embodiment has been described in detail, however, according to this embodiment, in recording via the network, plural recordings can be prevented from being simultaneously made in a specific recording device. In this embodiment, a recording device is determined after it is verified that a simultaneous recording reserved number is smaller than the maximum simultaneous recording number. Therefore, failure in recording can be prevented that results from the omission of the processing of a recording device and a hang-up in recording because of the shortage of the performance of the device in recording such as CPU performance, the writing speed to the storage, the simultaneous processing number of an encoder and a network band.

In relation to S2070 shown in FIG. 16, it is described that a device having a storage having the largest free capacity out of recording device candidates is automatically determined as a recording device, however, a user can also perform work to select a recording device out of recording device candidates. For a user, it is helpful that an optimum recording device is automatically determined, however, on the other hand, a user has need for the user himself/herself to determine in which recording device a broadcast program is to be recorded. An embodiment considering that will be described below.

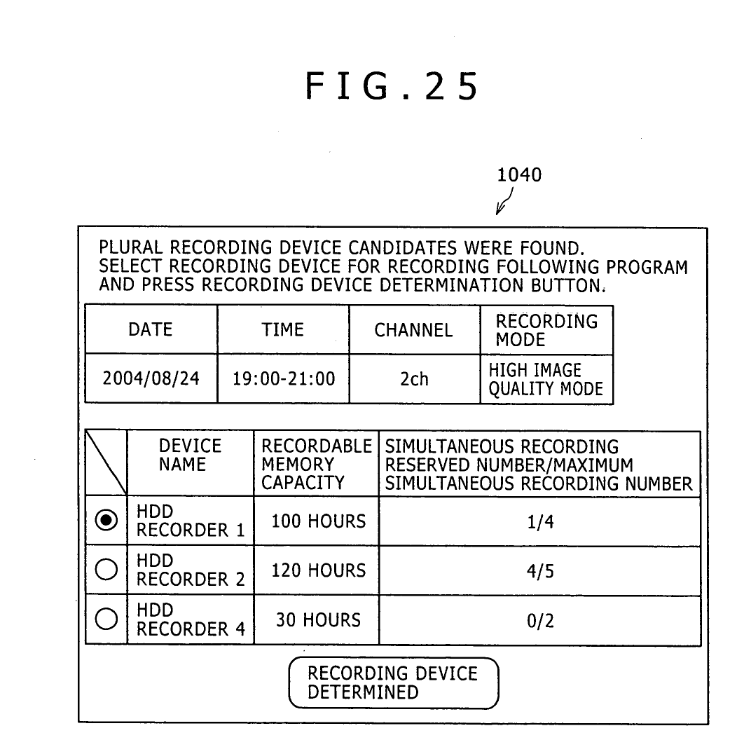

FIG. 25 shows an image of a recording device selection screen by a user 1040 when plural recording device candidates are found in a case where according to the procedure shown in FIG. 16, a recording device is determined when the user makes the reservation of recording.

On the screen shown in FIG. 25, the information of a program for which the user makes the reservation of recording and the information of a device to be a recording device candidate are displayed and the user can select the recording device out of the recording device candidates.

The information of the program shown in FIG. 25 for which recording reservation is made can be acquired from the recording reservation information table 720. Of the information of the device to be a recording device candidate shown in FIG. 25, recordable memory capacity can be acquired from the recording device candidate information table 730 shown in FIG. 9. Of the information of the device to be a recording device candidate shown in FIG. 25, a simultaneous recording reserved number/the maximum simultaneous recording number can be acquired from the value used in the step S2030 shown in FIG. 16.

Of the information of the device to be a recording device candidate shown in FIG. 25, a device name means a value used for a user to relate a displayed device and actual equipment and can be acquired as follows for example.

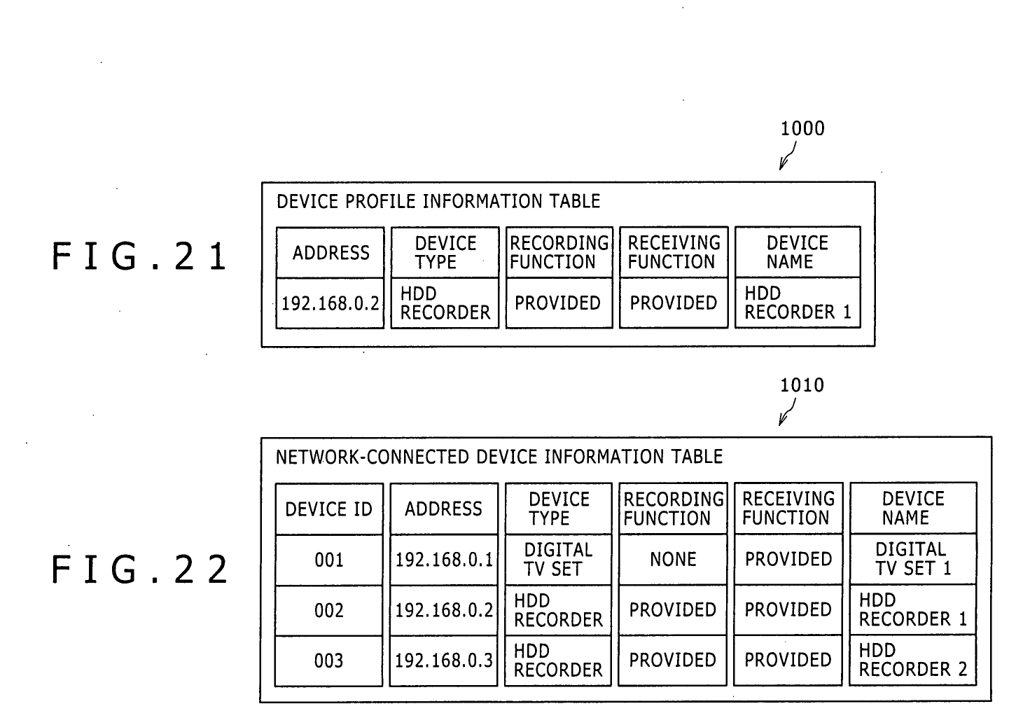

First, an item of a device name is added to the device profile information table 730 shown in FIG. 5 and a device profile information table 1000 shown in FIG. 21 is generated. In an item of a device name in the device profile information table 1000, a user sets a name by which a device can be identified or a system sets it beforehand (for example, a type number of the device).

Further, an item of a device name is added to the network-connected device information table 710 shown in FIG. 7 and a network-connected device information table 1010 shown in FIG. 22 is generated.

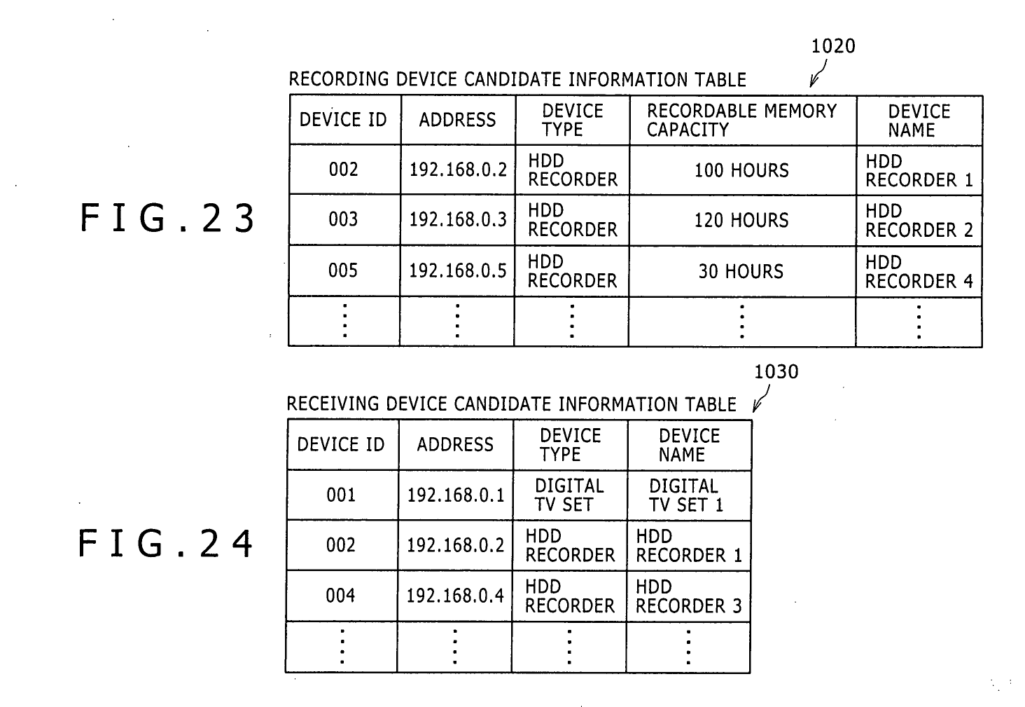

Furthermore, an item of a device name is added to the recording device candidate information table 730 shown in FIG. 9 and a recording device candidate information table 1020 shown in FIG. 23 is generated.

An item of a device name in the information of a device to be a recording device candidate in FIG. 25 can be acquired from the recording device candidate information table 1020 by storing the information of the device name in the device profile information table 1000 in the network-connected device information table 1010 and storing the information of the device name in the network-connected device information table 1010 in the recording device candidate information table 1020.

In relation to S5070 shown in FIG. 19, it is described that a device having a storage having the largest free capacity out of recording device candidates is determined as a recording device. However, a user can also perform work to select a recording device out of recording device candidates.

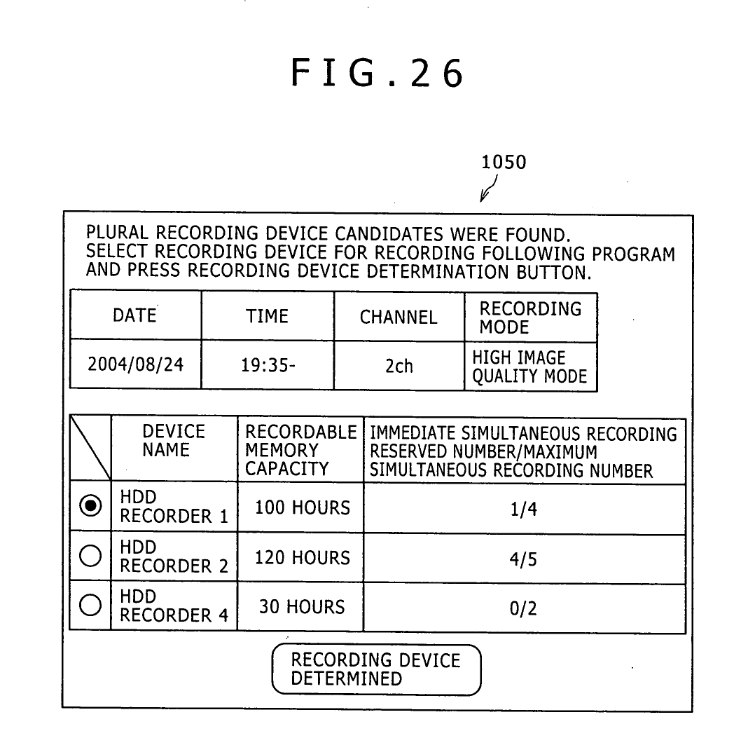

FIG. 26 shows an image of a recording device selection screen 1050 by a user in a case where plural recording device candidates are found when a recording device is determined according to the procedure shown in FIG. 19, when the user performs manual recording.

On the screen shown in FIG. 26, the information of a program for which the user performs manual recording and the information of the device to be a recording device candidate are displayed and the user can select the recording device out of the recording device candidates.

The information of the program shown in FIG. 25 for which manual recording is performed can be acquired from the current date and time, a channel and a recording mode when manual recording set in a system beforehand is performed.

An item of an immediate simultaneous recording reserved number/the maximum simultaneous recording number in the information of a device to be a recording device candidate in the image of the recording device selection screen 1050 shown in FIG. 26 can be acquired from the value used in the step S5030 in FIG. 19.

In relation to S3060 shown in FIG. 17, it is described that a device having a storage having the largest free capacity out of recording device candidates is determined as a recording device. However, a user can also perform work to select a recording device out of recording device candidates.

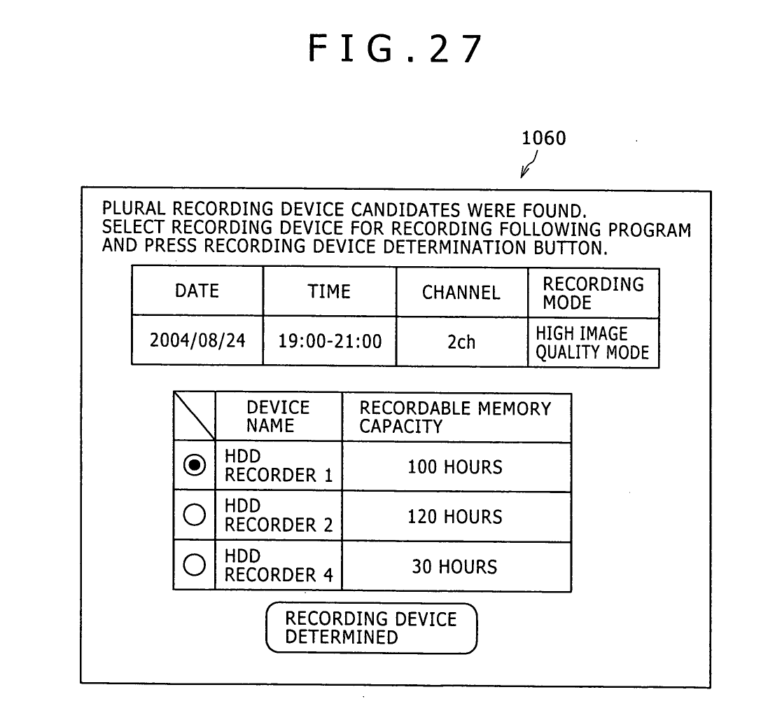

FIG. 27 shows an image of a recording device selection screen 1060 by a user in a case where plural recording device candidates are found when the recording device is determined according to the procedure shown in FIG. 17, when the user makes recording reservation.

On the screen shown in FIG. 27, the information a program for which the user makes recording reservation and the information of a device to be a recording device candidate are displayed and the user can select the recording device out of recording device candidates.

In relation to S4040 shown in FIG. 18, it is described that judgment is made such as determining a device having higher priority as a receiving device using any priority of a recording device out of receiving device candidates, for example, enhancing the priority of the HDD recorder 600, compared with the digital television set 500 the broadcast receiver 140 of which a user may use to watch television and enhancing the priority of a device having the same device ID as the device determined as a recording device to omit the transmission of data to the network 400 and then the receiving device is determined. However, a user can also perform work to select the receiving device out of receiving device candidates.

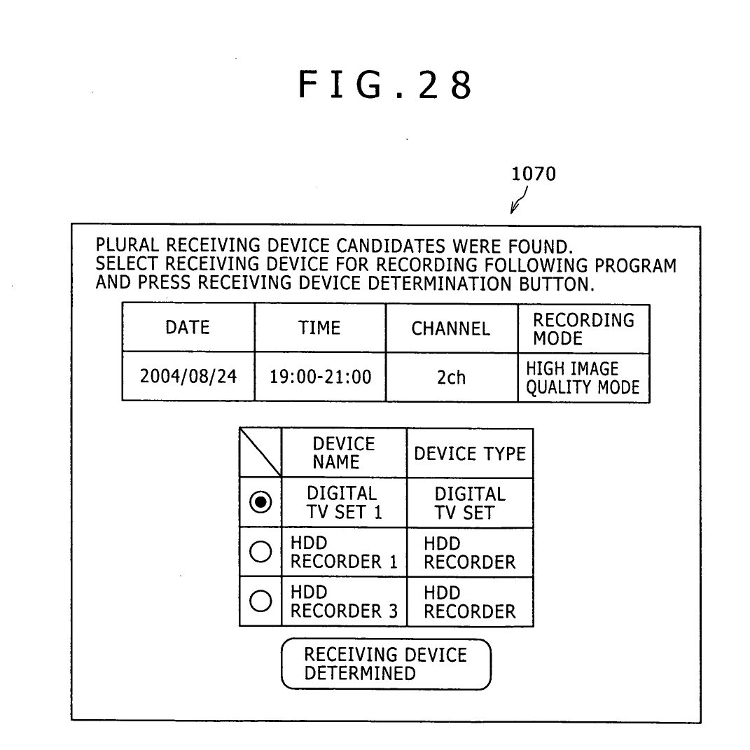

FIG. 28 shows an image of a receiving device selection screen 1070 by a user in a case where plural receiving device candidates are found when the receiving device is determined according to the procedure shown in FIG. 18, when a user makes recording reservation.

On the screen shown in FIG. 28, the information of a program for which the user makes recording reservation and the information of a device to be a recording device candidate are displayed and the user can select the receiving device out of receiving device candidates.

Of the information of the device to be a receiving device candidate shown in FIG. 28, a device type can be acquired from the receiving device candidate information table 740 shown in FIG. 10.

Of the information of the device to be a recording device candidate shown in FIG. 28, a device name is a value used for a user to relate the displayed device and actual equipment and can be acquired as follows for example.

First, an item of the device name is added to the receiving device candidate information table 740 shown in FIG. 10 and a receiving device candidate information table 1030 shown in FIG. 24 is generated.

An item of the device name in the information of the device to be a receiving device candidate shown in FIG. 28 can be acquired from the receiving device candidate information table 1030 by storing the information of a device name in the device profile information table 1000 in the network-connected device information table 1010 and storing the information of a device name in the network-connected device information table 1010 in the receiving device candidate information table 1030.

In this embodiment, if plural receiving device candidates or plural recording device candidates are found, it can also be set in the recording controller whether a user determines a receiving device or a recording device manually or the recording controller automatically determines it.

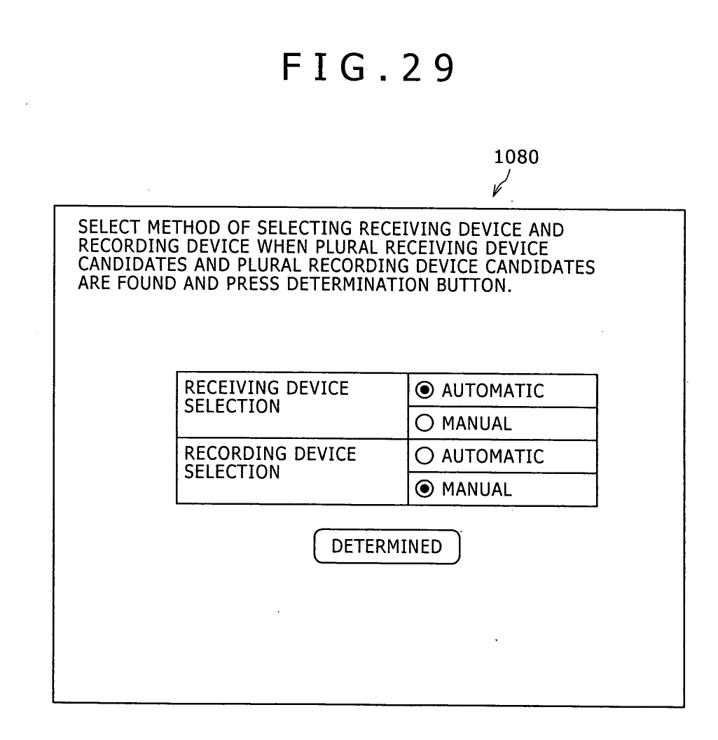

FIG. 29 shows an image of a screen 1080 for setting whether a user determines a receiving device or a recording device manually or the recording controller automatically determines it in the recording controller if plural receiving device candidates or plural recording device candidates are found.

As shown in FIG. 29, a user can select a method of selecting a receiving device and a recording device out of a method of automatically determining them by the recording controller and a method of determining them manually by the user.

A program related to the processes for outputting display screens shown in FIGS. 25 to 29 is stored in the main memory 520 beforehand and the processing of the display program is executed by the CPU 510. However, the invention is not limited to this and FIGS. 25 to 29 may also be displayed by installing the program for displaying FIGS. 25 to 29 via the Internet for example.

facility is enhanced when a user also selects using what parameter an optimum recording device is to be determined. Concretely, for example, “simple determination” and” detailed determination” are provided, in the case of “a simple determination mode”, an optimum recording device is determined using the free capacity of each data recording device and the maximum simultaneous recording number, and in the meantime, in the case of “a detailed determination mode”, an optimum recording device is determined using the free capacity of each data recording device, the maximum simultaneous recording number and the other information, for example, the performance of the CPU, the writing speed to the data recording device or a network band. Hereby, the user can also make selection for determining an optical recording device.

The best embodiments for embodying the invention have been described above, however, the above-mentioned embodiments are described to facilitate the understanding of the invention and do not limit the invention. The invention can be changed or improved without deviating from the object and equivalents are also included in the invention.

What is claimed is:

1. A data recording controller connected to at least one data recording device provided with a recording medium for recording data of broadcast voice and images via a network so that communication is possible, the data recording controller comprising:
a data recording reservation information input unit which receives, from a user interface, input of data recording reservation information at least including information showing recording start time and recording termination time of the data of broadcast voice and images and describing conditions when the data of voice and images is recorded;
a simultaneous data recording number receiving unit which receives, from each of the data recording devices, information showing the number of data pieces of voice and images which each of the data recording devices can write on each recording medium substantially simultaneously;
a data recording reservation number receiving unit which receives, from each of the data recording devices, information showing the number of data pieces of voice and images which each of the data recording devices is scheduled to write on each recording medium from the recording start time to the recording termination time respectively shown in the data recording reservation information; and
a data recording device candidate memory which stores identification information of a data recording device in which the number of data pieces of voice and images which are scheduled to be written on a recording medium from the recording start time to the recording termination time respectively shown in the data recording reservation information is smaller than the number of the substantially simultaneously writable data pieces of voice and images as a candidate of a data recording device for recording the data of voice and images from the recording start time to the recording termination time respectively shown in the data recording reservation information.

2. The data recording controller according to claim 1, comprising:
a memory capacity receiving unit which receives information stored in the data recording device candidate memory and showing free memory capacity of each recording medium with which each of the data recording devices is provided from each of the data recording devices;
a data recording device selecting unit which selects a data recording device provided with a recording medium of which the free memory capacity is the largest out of each of the data recording devices as a data recording device for recording the data of voice and images from recording start time to recording termination time respectively shown in the data recording reservation information; and
a recording request transmitting unit which transmits a request to record the data of voice and images to the selected data recording device according to conditions shown in the data recording reservation information.

3. A method of controlling a data recording controller connected to at least one data recording device provided with a recording medium f or recording data of broadcast voice and images via a network so that communication is possible, wherein:
input of data recording reservation information at least including information showing recording start time and recording termination time of the data of broadcast voice and images and describing conditions when the data of voice and images is recorded is received from a user interface;
information showing the number of data of voice and images which each of the data recording devices can write on each recording medium substantially simultaneously is received from each of the data recording devices;
information showing the number of data of voice and images which each of the data recording devices is scheduled to write on each recording medium from the recording start time to the recording termination time respectively shown in the data recording reservation information is received from each of the data recording devices; and
identification information of a data recording device where the number of data pieces of voice and images which are scheduled to be written to a recording medium from the recording start time to the recording termination time respectively shown in the data recording reservation information is smaller than the number of the substantially simultaneously writable data pieces of voice and images is stored as a candidate of a data recording device for recording the data of voice and images from the recording start time to the recording termination time respectively shown in the data recording reservation information.

4. A program for instructing a data recording controller connected to at least one data recording device provided with a recording medium for recording the data of broadcast voice and images via a network so that communication is possible to execute:
a procedure for receiving, from a user interface, input of data recording reservation information at least including information showing recording start time and recording termination time of the data of broadcast voice and image and describing conditions when the data of voice and images is recorded;
a procedure for receiving, from each of the data recording devices, information showing the number of data pieces of voice and images which each of the data recording devices can write on each recording medium substantially simultaneously;
a procedure for receiving, from each of the data recording devices, information showing the number of data of voice and images which each of the data recording devices is scheduled to write on each recording medium from the recording start time to the recording termination time respectively shown in the data recording reservation information; and
a procedure for storing identification information of a data recording device in which the number of data pieces of voice an images which are scheduled to be written to a recording medium from the recording start time to the recording termination time respectively shown in the data recording reservation information is smaller than the number of the substantially simultaneously writable data pieces of voice and images as a candidate of a data recording device for recording the data of voice and images from the recording start time to the recording termination time respectively shown in the data recording reservation information.

5. A data recording device connected to a data recording controller for receiving, from a user interface, input of data recording reservation information at least including information showing recording start time and recording termination time of data of broadcast voice and images and describing conditions when the data of voice and images is recorded via a network so that communication is possible, comprising:
a recording medium which records the data of broadcast voice and images;
a schedule memory which stores information showing a schedule in which the data of voice and images is written to the recording medium;
a data recording control unit which writes the data of broadcast voice and images to the recording medium according to the schedule;
a substantially simultaneous data recording number transmitting unit which transmits, to the data recording control unit, information showing the number of the data pieces of the data of voice and images which can be substantially simultaneously written to the recording medium; and
a data recording reserved number transmitting unit which transmits, to the data recording control unit, the number of the data of voice and images which are scheduled to be written to the recording medium from the recording start time to the recording termination time respectively shown in the data recording reservation information.

6. The data recording device according to claim 5, wherein:
the number of the data of voice and images which can be substantially simultaneously written to the recording medium is any of a number determined according to throughput of a CPU with which the data recording device is provided, a number determined according to a data writing speed to the recording medium with which the data recording device is provided, a number determined according to throughput of an encoder with which the data recording device is provided and a number determined according to a transmission speed when the data of voice and images is transmitted from a receiving device provided with a broadcast receiver for receiving broadcast voice and images to the data recording device, or the number is determined by a minimum value in the combination of two or more of the numbers.

7. A data recording controller connected to at least one data recording device provided with a recording medium for recording data of broadcast voice and images via a network so that communication is possible, comprising:
a broadcast receiver for receiving the broadcast voice and images;
a data recording request information input unit which receives input of data recording request information at least including information showing a request to record the data of voice and images being received and describing conditions when the data of voice and images is recorded from a user interface;
a substantially simultaneous data recording number receiving unit which receives, from each of the data recording devices, information showing the number of the data of voice and images which each of the data recording devices can substantially simultaneously write to each recording medium;
a data recording reserved number receiving unit which receives, from each of the data recording devices, information showing the number of the data pieces of voice and images which each of the data recording devices is scheduled to write to each recording medium for a predetermined period from the present time; and
a data recording device candidate memory which stores identification information of a data recording device in which the number of the data pieces of voice and image scheduled to be written to each recording medium for the predetermined period from the present time is smaller than the number of the data pieces of the substantially simultaneously writable data of voice and images as a candidate of a data recording device for recording the data of voice and images being received.

8. The data recording controller according to claim 7, comprising:
a memory capacity receiving unit which receives information stored in the data recording device candidate memory and showing free memory capacity of each recording medium with which each of the data recording devices is provided from each of the data recording devices;
a data recording device selecting unit which selects a data recording device provided with a recording medium of which free memory capacity is the largest out of each of the data recording devices as a data recording device for recording the data of voice and images being received; and
a recording request transmitting unit which transmits a request to record the data of voice and images being received to the selected data recording device according to conditions shown in the data recording request information.

9. A method of controlling a data recording controller connected to at least one data recording device provided with a recording medium for recording data of broadcast voice and images via a network so that communication is possible, wherein:
broadcast voice and images are received;
input of data recording request information at least including information showing a request to record the data of voice and images being received and describing conditions when the data of voice and images is recorded is received from a user interface;
information showing the number of the data pieces of voice and images which each of the data recording devices can substantially simultaneously write to each recording medium is received from each of the data recording devices;
information showing the number of the data pieces of voice and images which each of the data recording devices is scheduled to write to each recording medium for a predetermined period from the present time is received from each of the data recording devices; and
identification information of a data recording device in which the number of the data pieces of voice and images scheduled to be written to each recording medium for the predetermined period from the present time is smaller than the number of the substantially simultaneously writable data pieces of voice and images is stored as a candidate of a data recording device for recording the data of voice and images being received.

10. A data recording system provided with at least one data recording device having a recording medium for recording data of broadcast voice and images, at least one receiving device having a broadcast receiver for receiving broadcast voice and images and at least one data recording controller connected to each of the data recording devices and each of the receiving devices via a network so that communication is possible, wherein:
each of the data recording controllers is provided with:
a data recording reservation information input unit which receives input of data recording reservation information at least including information showing recording start time and recording termination time of the data of broadcast voice and images and describing conditions when the data of voice and images is recorded from a user interface;
a substantially simultaneous data recording number receiving unit which receives, from each of the data recording device, information showing the number of the data pieces of voice and images which each of the data recording devices can substantially simultaneously write to each recording medium;
a data recording reserved number receiving unit which receives, from each of the data recording devices, information showing the number of the data pieces of voice and images which each of the data recording devices is scheduled to write to each recording medium from the recording start time to the recording termination time respectively shown in the data recording reservation information;
a data recording device selecting unit which selects a data recording device selected out of each of the data recording devices in which the number of the data pieces of voice and images scheduled to be written to a recording medium from the recording start time to the recording termination time respectively shown in the data recording reservation information is smaller than the number of the substantially simultaneously writable data pieces of voice and images as a data recording device for recording the data of voice and images from the recording start time to the recording termination time respectively shown in the data recording reservation information;
a receiving schedule receiving unit which receives, from each of the receiving devices, information showing a schedule in which each of the receiving devices receives voice and images from the recording start time to the recording termination time respectively shown in the data recording reservation information;
a receiving device selecting unit which selects a receiving device selected out of the receiving devices which are not scheduled to receive voice and images from the recording start time to the recording termination time respectively shown in the data recording reservation information as a receiving device for receiving voice and images from the recording start time to the recording termination time respectively shown in the data recording reservation information;
a receiving request transmitting unit which transmits, to the selected receiving device, a receiving request to receive voice and images according to conditions shown in the data recording reservation information and to transmit the data of the received voice and images to the selected data recording device; and
a recording request transmitting unit which transmits, to the selected data recording device, a recording request to receive the data of voice and images from the selected receiving device and to record the data of the received voice and images according to conditions shown in the data recording reservation information;
each of the receiving devices is provided with:
a broadcast receiver for receiving broadcast voice and images;
a receiving schedule memory which stores information showing a schedule to receive voice and images;
a receiving schedule transmitting unit which transmits, to the data recording controller, information showing a schedule to receive voice and images from the recording start time to the recording termination time respectively shown in the data recording reservation information;
a broadcast receiving control unit which receives broadcast voice and images and transmitting them to a data recording device according to the schedule stored in the receiving schedule memory; and
a receiving schedule addition control unit which stores information showing a schedule to receive voice and images in the receiving schedule memory according to a receiving request transmitted from the data recording controller; and
each data recording device is provided with:
a recording medium which records the data of broadcast voice and images;
a schedule memory which stores information showing a schedule to write the data of voice and images to the recording medium;
a simultaneous data recording number transmitting unit which transmits, to the data recording controller, information showing the number of the data pieces which can be substantially simultaneously written to the recording medium of voice and images;
a data recording reserved number transmitting unit which transmits, to the data recording controller, the number of the data pieces of voice and images scheduled to be written to the recording medium from the recording start time to the recording termination time respectively shown in the data recording reservation information;
a data recording control unit which receives the data of broadcast voice and images from a receiving device and writing it to the recording medium according to the schedule stored in the schedule memory; and
a recording schedule addition control unit which stores information showing a schedule to write voice and images to the recording medium in the schedule memory according to a recording request transmitted from the data recording controller.

11. A data recording controller connected to at least one data recording device provided with a recording medium for recording data of broadcast voice and images and at least one receiving device provided with a broadcast receiver for receiving, from a user interface, broadcast voice and images via a network so that communication is possible, comprising:
a data recording reservation information input unit which receives input of data recording reservation information at least including information showing recording start time and recording termination time of the data of broadcast voice and images and describing conditions when the data of voice and images is recorded;
a simultaneous data recording number receiving unit which receives, from each of the data recording devices, information showing the number of data pieces of voice and images which each of the data recording devices can write to each recording medium substantially simultaneously;
a data recording reserved number receiving unit which receives, from each of the data recording devices, information showing the number of the data pieces of voice and images which each of the data recording devices is scheduled to write to each recording medium from the recording start time to the recording termination time respectively shown in the data recording reservation information;
a data recording device selecting unit which selects a data recording device selected out of the data recording devices in which the number of the data pieces of voice and images scheduled to be written to the recording medium from the recording start time to the recording termination time respectively shown in the data recording reservation information is smaller than the number of the substantially simultaneously writable data pieces of voice and images as a data recording device for recording the data of voice and images from the recording start time to the recording termination time respectively shown in the data recording reservation information;
a receiving schedule receiving unit which receives, from each of the receiving devices, information showing that each of the receiving devices is scheduled to receive voice and images from the recording start time to the recording termination time respectively shown in the data recording reservation information;
a receiving device selecting unit which selects a recording device selected out of the receiving devices which are not scheduled to receive voice and images from the recording start time to the recording termination time respectively shown in the data recording reservation information as a receiving device for receiving voice and images from the recording start time to the recording termination time respectively shown in the data recording reservation information;
a receiving request transmitting unit which transmits, to the selected receiving device, a receiving request to receive voice and images according to conditions shown in the data recording reservation information and to transmit the data of the received voice and images to the selected data recording device; and
a recording request transmitting unit which transmits, to the selected data recording device, a recording request to receive the data of voice and images from the selected receiving device and to record the data of the received voice and images according to conditions shown in the data recording reservation information.

12. A method of controlling a data recording controller connected to a first data recording device and a second data recording device via a network so that communication is possible, in the first data recording device provided with a first recording medium for recording data of broadcast voice and images, reservation to write the data of voice and images to the first recording medium is not set from recording start time to recording termination time respectively shown in data recording reservation information, and in the second data recording device provided with a second recording medium having larger memory capacity than that of the first recording medium for recording the data of broadcast voice and images, reservation to write the data of voice and images to the second recording medium is set from the recording start time to the recording termination time respectively shown in the data recording reservation information, wherein:
input of the data recording reservation information at least including information showing the recording start time and the recording termination time of the data of broadcast voice and images and describing conditions when the data of voice and images is recorded is received from a user interface, and
the first data recording device is selected as a data recording device for recording the data of voice and images from the recording start time to the recording termination time respectively shown in the data recording reservation information.

13. A data recording controller connected to at least one data recording device provided with a recording medium for recording data of broadcast voice and images via a network so that communication is possible, comprising:
a data recording reservation information input unit which receives, from a user interface, input of data recording reservation information at least including information showing recording start time and recording termination time of the data of broadcast voice and images and describing conditions when the data of voice and images is recorded;
a confirmation request transmitting unit which transmits, to each of the data recording devices, a request to confirm whether or not the recording of the data of voice and images from the recording start time to the recording termination time respectively shown in the data recording reservation information is possible;
a data recording device candidate selecting unit which selects a candidate of a data recording device for recording the data of voice and images from the recording start time to the recording termination time respectively shown in the data recording reservation information according to a result of a response to the request to confirm from each of the data recording devices; and
a data recording device candidate memory which stores identification information of the data recording device selected as the candidate.

14. The data recording controller according to claim 13, comprising:
a memory capacity receiving unit which receives information showing free memory capacity of each recording medium with which each of the data recording devices stored in the data recording device candidate memory is provided from each of the data recording devices;
a data recording device selecting unit which selects a data recording device provided with a recording medium having the largest free memory capacity out of the data recording devices as a data recording device for recording the data of voice and images from recording start time to recording termination time respectively shown in the data recording reservation information; and
a recording request transmitting unit which transmits, to the selected data recording device, a request to record the data of voice and images according to conditions shown in the data recording reservation information.

15. A data recording controller according to claim 13, wherein:
the data recording device candidate selecting unit selects a data recording device that transmits a response that the recording of the data of voice and images from recording start time to recording termination time is possible in response to the request to confirm as a candidate of a data recording device for recording the data of voice and images from the recording start time to the recording termination time respectively shown in the data recording reservation information.

16. A method of controlling a data recording controller connected to at least one data recording device provided with a recording medium for recording the data of broadcast voice and images via a network so that communication is possible, wherein:
input of data recording reservation information at least including information showing recording start time and recording termination time of the data of broadcast voice and images and describing conditions when the data of voice and images is recorded is received from a user interface;
a request to confirm whether or not the recording of the data of voice and images from the recording start time to the recording termination time respectively shown in the data recording reservation information is possible is transmitted to each of the data recording devices;
a candidate of a data recording device for recording the data of voice and images from the recording start time to the recording termination time respectively shown in the data recording reservation information is selected according to a result of a response to the request to confirm from each of the data recording devices; and
identification information of the data recording device selected as the candidate is stored.

17. A program for instructing a data recording controller connected to at least one data recording device provided with a recording medium for recording data of broadcast voice and images via a network so that communication is possible to execute:
a procedure for receiving, from a user interface, input of data recording reservation information at least including information showing recording start time and recording termination time of the data of broadcast voice and images and describing conditions when the data of voice and images is recorded;
a procedure for transmitting, to each of the data recording devices, a request to confirm whether or not the recording of the data of voice and images from the recording start time to the recording termination time respectively shown in the data recording reservation information is possible;
a procedure for selecting a candidate of a data recording device for recording the data of voice and images from the recording start time to the recording termination time respectively shown in the data recording reservation information according to a result of a response to the request to confirm from each of the data recording devices; and
a procedure for storing identification information of the data recording device selected as the candidate.

18. A data recording device connected to a data recording controller that receives, from a user interface, input of data recording reservation information at least including information showing recording start time and recording termination time of data of broadcast voice and images and describing conditions when the data of voice and images is recorded via a network so that communication is possible, comprising:
a recording medium which records the data of broadcast voice and images;
a schedule memory which stores information showing a schedule in which the data of voice and images is written to the recording medium;
a data recording control unit which writes the data of broadcast voice and images to the recording medium according to the schedule;
a confirmation request receiving unit which receives, from the data recording controller, a request to confirm whether or not the recording of the data of voice and images from the recording start time to the recording termination time respectively shown in the data recording reservation information is possible;
a recording possible/impossible determination unit which determines whether or not the recording of the data of voice and images from the recording start time to the recording termination time respectively shown in the data recording reservation information is possible; and
a response transmitting unit which transmits a response, according to a result of the determination, as to whether or not the recording of the data of voice and images from the recording start time to the recording termination time respectively shown in the data recording reservation information is possible to the data recording controller.

19. A data recording device according to claim 18, wherein:
the recording possible/impossible determination unit determines that, if the number of the data of voice and images which are scheduled to be written to the recording medium from recording start time to recording termination time respectively shown in the data recording reservation information is smaller than the number of the data of voice and images which can be substantially simultaneously written to the recording medium, the recording of the data of voice and images from the recording start time to the recording termination time is possible.

20. The data recording device according to claim 19, wherein:
the number of the data of voice and images which can be substantially simultaneously written to the recording medium is any of a number determined according to throughput of a CPU with which the data recording device is provided, a number determined according to a writing speed of the data to the recording medium with which the data recording device is provided, a number determined according to throughput of an encoder with which the data recording device is provided and a number determined according to a transmission speed when the data of voice and images is transmitted from a receiving device provided with a broadcast receiver for receiving broadcast voice and images to the data recording device, or the number is determined by a minimum value in the combination of two or more of the numbers.

21. A data recording controller connected to at least one data recording device provided with a recording medium for recording data of voice and images via a network so that communication is possible, comprising:
a data recording reservation information input unit which receives, from a user interface, input of data recording reservation information at least including information showing recording start time and recording termination time of the data of voice and images and describing conditions when the data of voice and images is recorded;
a data recording number receiving unit which receives, from each of the data recording devices, information showing the number of the data pieces of voice and images which each of the data recording devices can write to each recording medium in parallel;
a data recording reserved number receiving unit which receives, from each of the data recording devices, information showing the number of the data pieces of voice and images which each of the data recording devices is scheduled to write to each recording medium from the recording start time to the recording termination time respectively shown in the data recording reservation information;
a data recording device candidate memory which stores identification information of a data recording device in which the number of the data pieces of voice and images which are scheduled to be written to a recording medium from the recording start time to the recording termination time respectively shown in the data recording reservation information is smaller than the number of the data pieces writable in parallel of voice and images as a candidate of a data recording device for recording the data of voice and images from the recording start time to the recording termination time respectively shown in the data recording reservation information; and
a display which displays a screen for selecting one data recording device out of plural candidates if the plural candidates of a data recording device are stored in the data recording device candidate memory.

22. A data recording controller connected to a data recording device provided with a recording medium for recording data of voice and images via a network so that communication is possible, comprising:
a data recording reservation information input unit which receives, from a user interface, input of data recording reservation information at least including information showing recording start time and recording termination time of the data of voice and images and describing conditions when the data of voice and images is recorded;
a data recording number receiving unit which receives, from each of the data recording device, information showing the number of the data pieces of voice and images which each of the data recording devices can write to each recording medium in parallel;
a data recording reserved number receiving unit which receives, from each of the data recording devices, information showing the number of the data pieces of voice and images which each of the data recording devices is scheduled to write to each recording medium from the recording start time to the recording termination time respectively shown in the data recording reservation information;
a data recording device candidate memory which stores identification information of a data recording device in which the number of the data pieces of voice and images which are scheduled to be written to a recording medium from the recording start time to the recording termination time respectively shown in the data recording reservation information is smaller than the number of the data pieces writable in parallel of voice and images as a candidate of a data recording device for recording the data of voice and images from the recording start time to the recording termination time respectively shown in the data recording reservation information; and
a control unit which enables selection of whether the reservation of recording is made or not using the identification information stored in the data recording device candidate memory.

23. The data recording controller according to claim 22, wherein:
the control unit controls so that it can be selected on the same display screen using the identification information whether the reservation of recording is made or not and the reservation of recording is made on the same display screen.

24. The data recording controller according to claim 22, wherein:
the control unit controls so that the number of the data pieces of voice and images which are scheduled to be written to a recording medium from the recording start time to the recording termination time respectively shown in the data recording reservation information is determined using at least one of performance of a CPU of the data recording controller, the number of parallel processing of an encoder and information of a band of the network.
